(19) United States
(12) Patent Application Publication
(10) Pub. No.: US 2008/0227906 A1
(43) Pub. Date: Sep. 18, 2008

(54) COMPOSITION FOR FORMING COMPACT, DEGREASED BODY, AND SINTERED BODY

(75) Inventors: Masaaki SAKATA, Hachinohe (JP); Nobuyuki HAMAKURA, Hachinohe (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/048,806

(22) Filed: Mar. 14, 2008

(30) Foreign Application Priority Data
Mar. 15, 2007 (JP) 2007-067663

(51) Int. Cl. C08L 77/00

(52) U.S. Cl. 524/538

(57) ABSTRACT

A composition for forming a compact includes a powder mainly composed of an inorganic material, a first resin being decomposable by an action of an alkaline gas, and a binder including the first resin. The first resin is decomposed and removed from the compact formed by molding the composition for forming a compact by exposing the compact to a first atmosphere containing an alkaline gas so as to obtain a degreased body.

### BACKGROUND

1. Technical Field

The present invention relates to a composition for forming a compact, a degreased body, and a sintered body.

2. Related Art

In general, a sintered body of an inorganic material is obtained as follows: a compact is formed from a raw powder (mixed powder) that is an admixture of an inorganic material powder and a binder by using various forming methods such as an injection molding and the like; the compact is degreased at a temperature that is higher than a melting temperature of the binder and lower than a sintering temperature for the inorganic material so as to obtain a degreased body; and then the degreased body obtained is sintered.

However, for example, the raw powder used in the injection molding includes a relatively large quantity of a binder in order to improve liquidity while the injection molding is performed. For removing the binder, heat application is required for a long period, thereby causing issues such as decrease of production efficiency, and deformation of the compact during the heat treatment.

Further, when the binder in the compact is not completely removed by the heat treatment, and then the binder remaining is evaporated during sintering, cracks in the sintered body or the like may also occur.

In order to solve such issues, JP-A-3-170624 discloses a method for producing a sintered body and a mixture (composition) of an inorganic material powder and a binder used therein. The method to obtain the sintered body is as follows: a compact including a raw powder that is an admixture of an inorganic material powder and a binder containing polyacetal is treated with heat in an atmosphere containing acid in the form of a gas or boron trifluoride so as to obtain a degreased body, and the degreased body is sintered.

In general, acid that is a deleterious substance and boron trifluoride that is a poisonous substance are harmful to humans, thereby requiring a lot of troubles such as fully protective equipment for handling them.

Further, since acid and boron trifluoride have high metal solubility, materials having high corrosion resistivity need to be used for facilities, thereby causing a high cost.

Furthermore, since an atmosphere containing acid causes air pollution if it is released in the air after heat treatment, a cost to prevent it is incurred.

In addition to the above, polyacetal reacts with an atmosphere containing acid, generating formaldehyde. Since formaldehyde is combustible and flammable, and further, carcinogenic and toxicant, it may cause danger of fire and explosion, and health damage to workers.

Alternatively, a method for producing a sintered body by exposing a compact formed from a raw powder that is an admixture of an inorganic material powder and a binder containing an aliphatic carbonic acid ester based resin to an atmosphere containing ozone so as to degrease the compact, and then sintering the obtained degreased body has been known.

However, it has been found that even if degreasing is performed in the atmosphere containing ozone, the compact cannot be completely degreased.

Further, since ozone is extremely oxidative, in a case where a metal powder is used as the inorganic material powder, oxidization of the metal powder is also caused.

Further, a high cost of a degreasing step is also regarded as an issue because ozone that is consumed in large amounts during degreasing is a very expensive gas.

### SUMMARY

An advantage of the invention is to provide a composition for forming a compact, a degreased body and a compact having excellent characteristics and produced from the composition for forming a compact. The composition is used to securely and easily produce the degreased body and the compact at a low cost. The degreased body and the compact can realize production of a sintered body having excellent characteristics (dimensional precision, mechanical characteristics, appearance, and the like).

The above advantage is attained by the following aspects of the invention.

A composition for forming a compact according to a first aspect of the invention includes a powder mainly composed of an inorganic material; a first resin being decomposable by an action of an alkaline gas; and a binder including the first resin. The first resin is decomposed and removed from the compact formed by molding the composition for forming a compact by exposing the compact to a first atmosphere containing an alkaline gas so as to obtain a degreased body.

Accordingly, the composition for forming a compact used to securely and easily produce a degreased body and a compact at a low cost is obtained. From the degreased body and the compact, a sintered body having excellent characteristics (dimensional precision, mechanical characteristics, appearance, and the like) can be produced.

In this case, it is preferable that the first resin be decomposed at a temperature of from 20 to 190 degrees Celsius in the first atmosphere.

The compact is thus effectively degreased in a short time.

In this case, it is preferable that the first resin include an aliphatic polyester based resin as a main constituent.

The aliphatic polyester based resin is easily decomposed by contacting an alkaline gas, in addition, a decomposed matter generated after decomposing is hard to remain as a solidified substance, thereby being favorably used as the first resin.

In this case, it is preferable that the aliphatic polyester based resin include at least one of an aliphatic carbonic acid ester based resin and a polyhydroxycarboxylic acid based resin.

These resins are particularly easily and rapidly decomposed by contacting an alkaline gas. Further, since the decomposed matter is mainly composed of an evaporated matter, the decomposed matter is securely prevented from remaining in the degreased body. Furthermore, these resins have high wettability with an inorganic material powder, thereby providing a kneaded product that is sufficiently homogeneous even by a short time kneading.

In this case, it is preferable that the aliphatic carbonic acid ester based resin include a carbon number of from 2 to 11 in a part except a carbonate ester group in a repeating unit.

Therefore, the aliphatic carbonic acid ester based resin can be more easily and rapidly decomposed.

In this case, it is preferable that the aliphatic carbonic acid ester based resin have no unsaturated bonds in the part except the carbonate ester group.

According to the above, the aliphatic carbonic acid ester based resin contacts the alkaline gas, improving decomposing efficiency thereof. Therefore, the binder is more efficiently decomposed and removed.

In this case, it is preferable that the polyhydroxycarboxylic acid based resin include at least one of a poly lactic acid based resin and a polyglycolic acid based resin.

These resins have particularly high decomposition property among the polyhydroxycarboxylic acid based resins, thereby easily and rapidly decomposing at a relatively low temperature.

In this case, it is preferable the aliphatic polyester based resin have a weight average molecular weight of 10,000 to 300,000.

Thus a melting point and a viscosity of the aliphatic polyester based resin become optimum, improving the stability of the shape (shape retention) of the compact.

In this case, it is preferable that a content ratio of the first resin in the binder be 20 wt % or more.

Thus an effect to decompose and remove the first resin is more securely obtained, further accelerating degreasing of a whole of the binder.

In this case, it is preferable that a content ratio of the binder in the composition for forming a compact be from 2 to 40 wt %.

Accordingly, the compact can be formed with favorable moldability and with higher density, making the compact especially superior in the stability of the shape and the like.

In this case, it is preferable that the binder further include a second resin decomposing later than the first resin.

Therefore, for example, the first resin and the second resin in the compact are respectively decomposed in different temperature regions in the degreasing. That is, each of the first resin and the second resin in the compact is selectively decomposed and removed (degreased). As a result, the progress of the degreasing of the compact can be controlled, easily and surely providing a degreased body that is superior in shape retention, i.e. dimensional precision.

In this case, it is preferable that the second resin be decomposed at a temperature of from 180 to 600 degrees Celsius.

The second resin can thus be efficiently and securely decomposed and removed.

In this case, it is preferable that the second resin include at least one of polystyrene and polyolefin as a main constituent.

These materials can have a high bonding strength in the degreased body, thereby surely preventing the degreased body from transforming. Further, these materials have high liquidity and are easily decomposed by heat application, being easily degreased. As a result, the degreased body having excellent dimensional precision can be more securely obtained.

In this case, it is preferable that an alkaline gas concentration of the first atmosphere be from 20 vol % to 100 vol %.

Thus the first resin can be efficiently and securely decomposed and removed.

In the composition for forming a compact according to the aspect, it is preferable that the compact be exposed at least once to a second atmosphere containing a low concentrated alkaline gas whose alkaline gas concentration is lower than the alkaline gas concentration of the first atmosphere after being exposed to the first atmosphere so as to obtain the degreased body.

Accordingly, a gas of the first atmosphere remaining in the degreased body is substituted by a gas of the second atmosphere. Then, contact frequency of the inorganic material and the alkaline gas in the degreased body is reduced, preventing the inorganic material from being nitrided. Consequently, a sintered body that is particularly superior in various characteristics is obtained.

In this case, it is preferable that the second atmosphere used in a final stage of exposing the compact to the second atmosphere do not substantially include an alkaline gas.

Thus the alkaline gas is removed more or less from the degreased body, more securely preventing the inorganic material in the degreased body from being nitrided.

In this case, it is preferable that a temperature of the second atmosphere be lower than a temperature of the first atmosphere.

Therefore, a reducing action of the alkaline gas of the second atmosphere in the degreased body is further reduced, and the inorganic material in the degreased body is more securely prevented from being nitrided.

In this case, it is preferable that the second atmosphere include a non-oxygenated gas as a main constituent other than the alkaline gas.

According to the above, while the inorganic material is prevented from being nitrided, the inorganic material, in particular, a metal material can be prevented from oxidizing.

In this case, it is preferable that the compact be exposed to the first atmosphere and the second atmosphere in a continuous furnace.

This enables a plurality of the degreased bodies to be treated at a time and in continuity so as to produce the sintered body, thereby improving production efficiency of the sintered body. Further, with the continuous furnace, the degreased body is prevented from being exposed to the air in the middle of producing the sintered body. Therefore, especially the metal material contained in the degreased body can be securely prevented from oxidizing caused by contacting the degreased body with the air.

In this case, it is preferable that the continuous furnace have a zone arranged to have an alkaline gas concentration inside the continuous furnace decreased in a middle of a traveling direction of the compact so that the compact is sequentially exposed to the first atmosphere and the second atmosphere while the compact passes through the zone.

These steps are thus conducted in a shorter time.

A degreased body according to a second aspect of the invention is obtained by degreasing the compact obtained by molding the composition for forming a compact according to the above through exposure to the second atmosphere.

Accordingly, the degreased body having excellent characteristics (dimensional precision, mechanical characteristics, and the like) is obtained.

In this case, it is preferable that the degreased body be formed from the compact molded by one of injection molding and extrusion molding.

In the injection molding, a compact in a complex and fine shape can be easily formed by selecting a molding tool. Further, in the extrusion molding, a compact in a column or plate-like shape having a desired extruded surface can be especially easily formed at a low cost by selecting a molding tool.

A sintered body according to a third aspect of the invention is formed by sintering the degreased body according to the second aspect.

Thus the sintered body having excellent characteristics (dimensional precision, mechanical characteristics, appearance, and the like) is obtained.

Further, the composition for forming a compact preferably includes an additive.

The binder can thus bring out the function of the additive and the additive can be decomposed and removed without adversely affecting the shape retention and the dimensional precision of the degreased body during the degreasing.

The additive preferably includes a dispersant to improve dispersibility of the powder in the composition for forming a compact.

According to the above, the powder, the first resin, and the second resin can disperse more evenly in the composition. Therefore, the degreased body and the sintered body to be obtained can have less variation in their characteristics, being more homogeneous.

The dispersant preferably includes a higher fatty acid as a main constituent.

Thus the dispersibility of the powder in the composition is particularly improved.

A carbon number of the higher fatty acid is preferably in a range from 16 to 30.

Accordingly, the composition can prevent deterioration of the moldability during the molding to have excellent shape retention. Further, the higher fatty acid can easily decompose even at a relatively low temperature.

### BRIEF DESCRIPTION OF THE DRAWINGS

The invention will be described with reference to the accompanying drawings, wherein like numbers reference like elements.

FIG. 1 is a flow chart showing a method for producing a degreased body and a sintered body using a composition for forming a compact according to a first embodiment.

FIG. 2 is a diagram schematically showing the composition for forming a compact according to the first embodiment.

FIG. 3 is a longitudinal sectional view schematically showing a compact formed from the composition for forming the compact.

FIG. 4 is a longitudinal sectional view schematically showing a first degreased body obtained in the first embodiment of the method for producing a degreased body and a sintered body using the composition for forming the compact.

FIG. 5 is a longitudinal sectional view schematically showing a first degreased body obtained in the first embodiment for the method for producing a degreased body and a sintered body using the composition for forming the compact.

FIG. 6 is a longitudinal sectional view schematically showing a sintered body according to the invention.

FIG. 7 is a plan view schematically showing a continuous furnace used in the first embodiment for the method for producing a degreased body and a sintered body using the composition for forming the compact.

FIG. 8 is a plan view schematically showing a continuous furnace used in a second embodiment for the method for producing a degreased body and a sintered body using the composition for forming the compact.

FIG. 9 is a plan view schematically showing a continuous furnace used in a third embodiment for the method for producing a degreased body and a sintered body using the composition for forming the compact.

### DESCRIPTION OF EXEMPLARY EMBODIMENTS

Now, exemplary embodiments of a composition for forming a compact, a degreased body, and a sintered body according to the invention will be described with accompanying drawings.

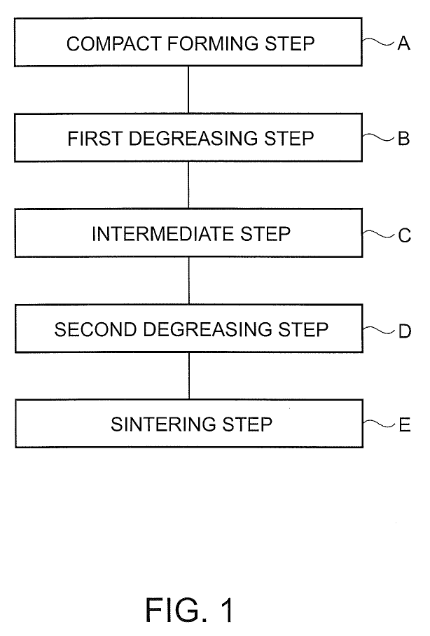

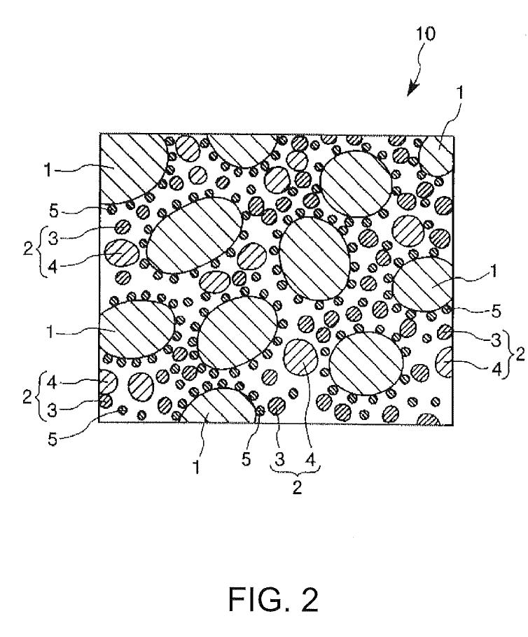

FIG. 1 is a flow chart showing a method for producing the degreased body and the sintered body using the composition for forming a compact while FIG. 2 is a diagram schematically showing the composition for forming a compact according to the first embodiment.

<Composition for Forming a Compact>

Now, a composition (the composition for forming a compact according to the embodiments) 10 that is used for forming a degreased body or a compact that is a preliminary stage of the degreased body will be described.

The composition 10 contains a powder 1 mainly composed of an inorganic material and a binder 2. Further, in the embodiments, the binder 2 includes a first resin 3 and a second resin 4.

[1] Powder

The powder 1 is mainly composed of the inorganic material.

The inorganic material is not limited. Examples of the inorganic material include: a metal material such as Fe, Ni, Co, Cr, Mn, Zn, Pt, Au, Ag, Cu, Pd, Al, W, Ti, V, Mo, Nb, Zr, Pr, Nd, and Sm; an oxide based ceramic material such as alumina, magnesia, beryllia, zirconia, yttria, forsterite, steatite, wollastonite, mullite, cordierite, ferrite, sialon, and cerium oxide; a non-oxide based ceramic material such as silicon nitride, aluminum nitride, boron nitride, titanium nitride, silicon carbide, boron carbide, titanium carbide, and tungsten carbide; and a carbonaceous material such as graphite, nano-carbon (carbon nanotube, and fullerene, for example). These can be used singly or in combination.

Since the composition 10 has excellent moldability as described later, the present invention is suitably used in a case where a material that has relatively high hardness and is difficult to be processed, as a material for forming a sintered body.

Specific examples of the metal material include: Fe alloy typified by stainless steel such as SUS304, SUS316, SUS316L, SUS317, SUS329J1, SUS410, SUS430, SUS440, and SUS630, die steel, and high-speed tool steel; Ti or Ti alloy; W or W alloy; Co cemented carbide; and Ni cermet.

Use of two or more kinds of materials having different compositions from each other makes possible to provide a sintered body having a composition that has been impossible to be produced by casting in related art. Further, a sintered body having new and multiple functions can be easily produced, achieving an expansion of functions and applications of the sintered body.

The average particle diameter of the powder 1 is not limited, but is preferably in a range from about 0.3 to 100 μm, more preferably in a range from about 0.5 to 50 μm. If the average particle diameter of the powder 1 is in the above range, a compact and a sintered body to be obtained by degreasing and sintering the compact can be formed with excellent moldability (easiness in molding). In addition, the average particle diameter in the above range can increase a density of the sintered body to be obtained, and further improve characteristics such as mechanical strength and dimensional precision of the sintered body. On the other hand, if the average particle diameter of the powder 1 is less than the above lower limit, the moldability of the compact deteriorates. If the average particle diameter of the powder 1 exceeds the above upper limit, the density of the sintered body becomes hard to be sufficiently increased and thus the characteristics of the sintered body may deteriorate.

In the embodiments, the “average particle diameter” means a particle diameter of powder ranging 50% of accumulative content in a target powder particle diameter distribution.

The powder 1 can be formed in any method. For example, in a case where the powder 1 is made of a metal material, the powder 1 may be formed by various atomization processes such as a liquid atomization like a water atomization (for example, a high speed spinning water atomization, and a spinning water atomization), and a gas atomization; and chemical processes such as pulverizing, a carbonyl process, and a reduction method.

[2] Binder

The binder 2 is a component largely affecting the moldability (easiness in molding) of the composition 10 and stability of a shape (shape retention) of the compact and the degreased body in a compact forming described later. If the composition 10 contains such component, a sintered body having excellent dimensional precision can be easily and surely formed.

In the embodiments, the binder 2 includes the first resin 3 that is decomposable by an action of an alkaline gas. Further, in the embodiments, the binder 2 that includes the first resin 3 and the second resin 4 that decomposes later than the first resin 3.

The first resin 3 has a property to decompose by contacting an alkaline gas. The compact including the first resin 3 with the property as above progresses decomposition of the first resin 3 from the surface of the compact to the inside even at a relatively low temperature by contacting an alkaline gas in a first degreasing step described later. Since the degreasing is performed through such a process, unlike degreasing in related art, the compact is prevented from being deformed caused by rapid softening of the binder included in the compact due to a high temperature, and from being distorted and cracked by sudden exhaust of the binder evaporated inside the compact to outside.

That is, according to the embodiments, the first resin is easily and rapidly removed (degreased). As the above, time required for a total degreasing process can be reduced and production efficiency of the degreased body, that is, production efficiency of the sintered body can be improved while maintaining the shape retention of the degreased body.

The first resin 3 as above is not particularly limited as long as it is a resin that is decomposable by an action of an alkaline gas. However, one that is decomposable at 20 to 190 degrees Celsius is preferable, and further, one that is decomposable at 70 to 170 degrees Celsius is more preferable. The binder 2 includes a resin decomposable at a relatively low temperature as the above, efficiently performing degreasing of the compact for a short time.

Further, when the binder 2 includes the second resin 4, difference of decomposition temperatures between the first resin 3 and the second resin 4 becomes larger. Therefore, each of the first resin 3 and the second resin 4 is decomposed in an individual temperature range, thereby decomposition of the binder 2 as a whole is gradually progressed. As a result, the compact is more securely prevented from being distorted and cracked.

The content rate of the first resin 3 contained in the binder 2 is preferably 20 wt % or more, more preferably 30 wt % or more, and further more preferably 40 wt % or more. If the content rate of the first resin 3 contained in the binder 2 is within the range above, the first resin 3 can be more securely decomposed and removed, enabling degreasing of the whole of the binder 2 with a lower temperature and a higher speed.

Examples of the first resin 3 as above include a resin that is decomposable by an action of an alkaline gas such as a resin having ester binding (polyester based resin) or the like.

More specifically, for example, an aliphatic polyester based resin, a polyether based resin and the like are cited. They may be used singly or in combination.

Further, among these resins, in particular, one containing an aliphatic polyester based resin as a main constituent is preferable as the first resin 3. The aliphatic polyester based resin is easily decomposed by contacting an alkaline gas, in addition, a decomposed matter generated after the decomposition is hard to remain as a solidified substance, thereby being favorably used as the first resin 3.

Further, examples of the aliphatic polyester based resin include: aliphatic carbonic acid ester based resin such as alkanediol polycarbonate, and polyalkylene carbonate, polyhydroxycarboxylic acid based resin, polyhydroxypolycarboxylic acid based resin such as polyethylene succinate, polybutylene succinate; hydroxyearboxylic acid-polycarboxylic-polyol copolymer based resin such as lactic acid-dicarboxylic acid-diol copolymer; and the like or derivatives of these resins. In addition, the resins may be used singly or in combination.

Among them, in particular, one that includes at least one of an aliphatic carbonic acid ester based resin and a polyhydroxycarboxylic acid based resin as a main constituent is preferable as the aliphatic polyester based resin. These resins are particularly easily and rapidly decomposed by contacting an alkaline gas. Further, since the decomposed matter is mainly composed of an evaporated matter, the decomposed matter is securely prevented from remaining in the degreased body. Furthermore, these resins have high wettability with an inorganic material powder, thereby providing a kneaded product that is sufficiently homogeneous even by a short time kneading.

Now, the aliphatic carbonic acid ester based resin will be described in detail.

In the aliphatic carbonic acid ester based resin, the number of carbons in a repeating unit other than a carbonate ester group, that is, the number of carbons existing between carbonate ester groups in the resin is preferably in a range from 2 to 11, more preferably in a range from 3 to 9, and furthermore preferably in a range from 4 to 7. The number of carbons means the number of “m”s in a case where the aliphatic carbonic acid ester based resin is expressed by a general formula: —((CH₂)ₘ—O—CO—O)ₙ—, for example. If the number of carbons is within the above ranges, the aliphatic carbonic acid ester based resin can be more easily and rapidly decomposed.

In particular, examples of the aliphatic carbonic acid ester based resin include: polyethylene carbonate; polypropylene carbonate; polytrimethylene carbonate; poly1,4-butylene carbonate; poly1,2-butylene carbonate; poly1,2-isobutylene carbonate; poly1,5-heptylene carbonate; 1,2-heptylene carbonate; poly1,6-hexylene carbonate; poly1,2-hexylene carbonate; polyphenylethylene carbonate; polycyclohexylene carbonate; polymethoxyethylene carbonate; and polyalkylene carbonate such as polyphenoxyethylene carbonate; or these copolymers, and ethanediol polycarbonate; propanediol polycarbonate; butanediol polycarbonate; hexanediol polycarbonate; and alkanediol polycarbonate such as decanediol polycarbonate; or derivatives of these aliphatic carbonic acid ester based resins. They may be used singly or in combination.

Among these examples of the aliphatic carbonic acid ester based resin, polypropylene carbonate is especially preferable.

The aliphatic carbonic acid ester based resin can be synthesized, for example, by a phosgene process in which phosgene or its derivative and aliphatic diol are reacted in the presence of a base; a copolymerization process by a zinc catalyst containing an epoxy compound and carbon dioxide; and a transesterification process between diol and organic carbonate ester.

Here, the aliphatic carbonic acid ester based resin decomposes by contacting an alkaline gas, and the decomposed matter vaporizes to be exhausted as a gas to the outside of the compact. Examples of the decomposed matter include: alkylene oxide (for example, ethylene oxide and propylene oxide) and its decomposed matter; alkylene carbonate; water; and carbon dioxide. The aliphatic carbonic acid ester based resin described above has a high decomposition property, so that the degreasing can be more securely conducted in the first degreasing step. Accordingly, total time required for degreasing can be further reduced.

Further, it is preferable that the aliphatic carbonic acid ester based resin have no unsaturated bonds in a part except the carbonate ester group. According to the above, the aliphatic carbonic acid ester based resin contacts an alkaline gas, improving decomposing efficiency thereof. Therefore, the binder 2 is efficiently decomposed and removed.

Next, a polyhydroxycarboxylic acid based resin will be described in detail.

Examples of the polyhydroxycarboxylic acid based resin include: poly lactic acid based resin such as poly-L-lactic acid, poly-D-lactic acid, and poly-L/D-lactic acid; polyglycolic acid based resin, polyglycolide based resin, polylactide based resin, lactide copolymer based resin, polyε-caprolactone based resin; and their copolymers. They may be used singly or in combination.

Among the examples of the polyhydroxycarboxylic acid based resin described above, in particular, one including at least one of a poly lactic acid based resin and a polyglycolic acid based resin as a main constituent is preferable. These resins have a particularly high decomposition property among the polyhydroxycarboxylic acid based resins, thereby easily and rapidly decomposing at a relatively low temperature. Further, these resins have high wettability with the inorganic material powder, thereby providing a kneaded product that is sufficiently homogeneous even by a short time kneading.

Such a polyhydroxycarboxylic acid based resin decomposes by contacting an alkaline gas, and the decomposed matter vaporizes to be exhausted as a gas to the outside of the compact. Examples of the decomposed matter include: a lactic acid molecule and its decomposed matter; water; and carbon dioxide.

The aliphatic polyester based resin typified by such an aliphatic carbonic acid ester based resin and a polyhydroxycarboxylic acid based resin preferably has a weight average molecular weight of about 10,000 to 300,000, more preferably about 20,000 to 200,000. Accordingly, a melting point and a viscosity of the aliphatic polyester based resin become optimum, improving the stability of the shape (shape retention) of the compact.

Further, in the embodiments, the binder 2 further includes the second resin 4 that decomposes later than the first resin 3.

The second resin 4 is not substantially decomposed in degreasing conditions for decomposing and removing the first resin 3, but decomposed and removed in degreasing conditions different from the degreasing conditions described above. Then, in the embodiments, the second resin 4 is not decomposed in the first degreasing step described later, but decomposed and removed in the second degreasing step by treatment with a higher temperature than that in the first degreasing step.

Specific examples of the second resin 4 that decomposes later than the first resin 3 as described above include one in which a heat decomposition temperature thereof is higher than a melting point of the first resin 3, and the like. Further, if the binder 2 includes the second resin 4 as above, the first resin 3 and the second resin 4 are respectively decomposed in different temperature regions in the degreasing step. That is, the degreasing step according to the embodiments is separated into the first degreasing step and the second degreasing step performed thereafter. Therefore, each of the first resin 3 and the second resin 4 in the compact is selectively decomposed and removed (degreased). As a result, the progress of the degreasing of the compact can be controlled, easily and surely providing a degreased body that is superior in shape retention, i.e. dimensional precision.

Further, as described later, a degreased body that is obtained by decomposing and removing the first resin 3 only (hereinafter, referred to as “first degreased body”) in the first degreasing step has particles therein being bound to each other by the second resin 4. Therefore, the first degreased body has toughness as a whole, but its hardness is not as high as that of the sintered body. Therefore, various machining can be easily performed to the first degreased body.

The second resin 4 is not particularly limited, but it preferably has a weight average molecular weight of about 1,000 to 400,000, more preferably about 4,000 to 300,000. Such the second resin 4 can have an optimum melting point and viscosity, further improving stability of the shape (shape retention) of the compact.

The second resin 4 is not particularly limited as long as a heat decomposition temperature thereof is higher than the melting point of the first resin 3 contained in the binder 2. Examples of the second resin 4 include: styrene resin such as polystyrene; polyolefin such as polyethylene, polypropylene, and ethylene-vinyl acetate copolymer; acrylic resin such as polymethyl methacrylate and polybutyl methacrylate; polyester such as polyvinyl chloride, polyvinylidene chloride, polyamide, polyethylene terephthalate, and polybutylene terephthalate; polyvinyl alcohol; and their copolymers. They may be used singly or in combination.

Among them, the second resin 4 preferably contains at least one of polystyrene and polyolefin as a main constituent. These materials can serve a high bonding strength in the degreased body, thereby surely preventing the degreased body from transforming. Further, these materials have a high liquidity and are easily decomposed by heat application, thereby being easily degreased. As a result, a degreased body and a sintered body that have excellent dimensional precision can be more securely obtained.

The state of the binder 2 can be in any states as it is not particularly limited. However, for example, the binder 2 may be in a powdery state, a liquid state, or a gelled state.

Further, the content rate of the binder 2 in the composition 10 is not particularly limited, but is preferably in a range from about 2 to 40 wt %, more preferably in a range from about 5 to 30 wt %. If the content rate of the binder 2 is in the above range, a compact can be formed with preferable moldability and with a high density, making the compact especially superior in a shape stability and the like.

Other examples of the second resin 4 that decomposes later than the first resin 3 include: one that is decomposable by ultraviolet rays and can be decomposed by ultraviolet ray irradiation treatment in the second degreasing step described later, and one that is decomposable by acid and can be decomposed by contacting an atmosphere containing acid in the second degreasing step, and the like.

Further, the composition 10 may contain an additive.

The additive is preferably decomposed and removed together with the second resin 4 in the second degreasing step to be described later. Accordingly, the binder 2 can bring out the function of the additive and the additive can be decomposed and removed without adversely affecting the shape retention and the dimensional precision of the degreased body.

Examples of the additive may include a dispersant (a lubricant), a plasticizer, and an antioxidant. They may be used singly or in combination. The additive is added to the composition 10, enabling the composition 10 to bring out various functions of the additive.

Among these, dispersants 5 adhere to the periphery of the powder 1 as shown in FIG. 2, improving the dispersibility of the powder 1 in the composition 10. Namely, the composition 10 contains the dispersants 5, so that the first powder 1, the first resin 3, and the second resin 4 can disperse more evenly. Therefore, a degreased body and a sintered body to be obtained can have less variation in their characteristics, being more homogeneous.

The dispersants 5 may serve as a lubricant, that is, a function enhancing a liquidity of the composition 10 in a compact forming step described later. Thus a filling property of the composition 10 with respect to the molding die is improved, providing a sintered body having an even density.

Examples of the dispersants 5 include: higher fatty acid such as stearic acid, distearate, tristearate, linolenic acid, octane acid, oleic acid, palmitic acid, and naphthenic acid; an anionic organic dispersant such as polyacrylic acid, polymethacrylate, polymaleic acid, acrylic acid-maleic acid copolymer, and polystyrene sulfonate; a cationic organic dispersant such as quaternary ammonium salt; a nonionic organic dispersant such as polyvinyl alcohol, carboxymethylcellulose, and polyethyleneglycol; and an inorganic dispersant such as calcium phosphate tribasic.

Among these, one containing the higher fatty acid as a main constituent is preferable as the dispersants 5. The higher fatty acid is especially superior in dispersibility of the powder 1.

A carbon number of the higher fatty acid is preferably in a range from 16 to 30, more preferably 16 to 24. If the carbon number of the higher fatty acid is in the above range, the composition 10 prevents deterioration of the moldability to have excellent shape retention. Further, if the carbon number is in the above range, the higher fatty acid can easily decompose even at a relatively low temperature.

The plasticizer gives flexibility to the composition 10 so as to facilitate molding in the compact forming step described later.

Examples of the plasticizer include: phthalic acid ester (e.g. DOP, DEP, and DBP); adipic acid ester; trimellitic acid ester; and sebacic acid ester.

The antioxidant prevents a resin constituting the binder from oxidizing.

Examples of the antioxidant include: a hindered phenol antioxidant; and a hydrazine antioxidant.

The composition 10 containing above components can be prepared by mixing powders corresponding to the respective components. The components may be mixed in any atmosphere, but preferably mixed under a vacuumed or decompressed state (3 kPa or less, for example), or in a non-oxidizing atmosphere such as in an inert gas. Examples of the inert gas may include nitrogen gas, argon gas, and helium gas. Thus, especially the metal material contained in the composition 10 can be prevented from oxidizing.

After being mixed, the components may be kneaded as necessary. Accordingly, a bulk density of the composition 10 increases and a compositional uniformity improves, so that a compact having a higher density and a high uniformity can be obtained, also improving dimensional precisions of the degreased body and the sintered body.

The components of the composition 10 can be kneaded by various kneaders such as a pressure or double arm kneader, a roll kneader, a Banbury kneader, and a single or double screw extruder, but preferably kneaded by the pressure kneader in particular. Since the pressure kneader can apply high pressure on the composition 10, it can securely knead the composition 10 containing the powder 1 having high hardness or the composition 10 having high viscosity.

Kneading conditions vary depending on a composition or a particle diameter of the powder 1 to be used, a composition of the binder 2, a blending quantity of these, and the like. An example of the conditions are the following: a kneading temperature of from about 50 to about 200 degrees Celsius, and a kneading time of from about 15 to about 210 minutes. The kneading may be conducted in any atmosphere similarly to the mixing described above, but preferably conducted under a vacuumed or decompressed state (3 kPa or less, for example), or in a non-oxidizing atmosphere such as in an inert gas. Examples of the inert gas may include nitrogen gas, argon gas, and helium gas. Thus, especially the metal material contained in the composition 10 can be prevented from oxidizing in the same manner as above.

Furhter, the kneaded product (compound) that is obtained is crushed to be pelletized (become small mass) as necessary. The particle, diameter of the pellet is, for example, about 1 to 10 mm.

The kneaded product can be pelletized with a crusher such as a pelletizer.

[Producing Degreased Body and Sintered Body]

Next a method for producing the degreased body and the sintered body according to the embodiments of the invention by using the composition (the composition for forming a compact according to the invention) 10 will be described.

### First Embodiment

First, a method for producing a degreased body and a sintered body according to a first embodiment of the embodiments will be described.

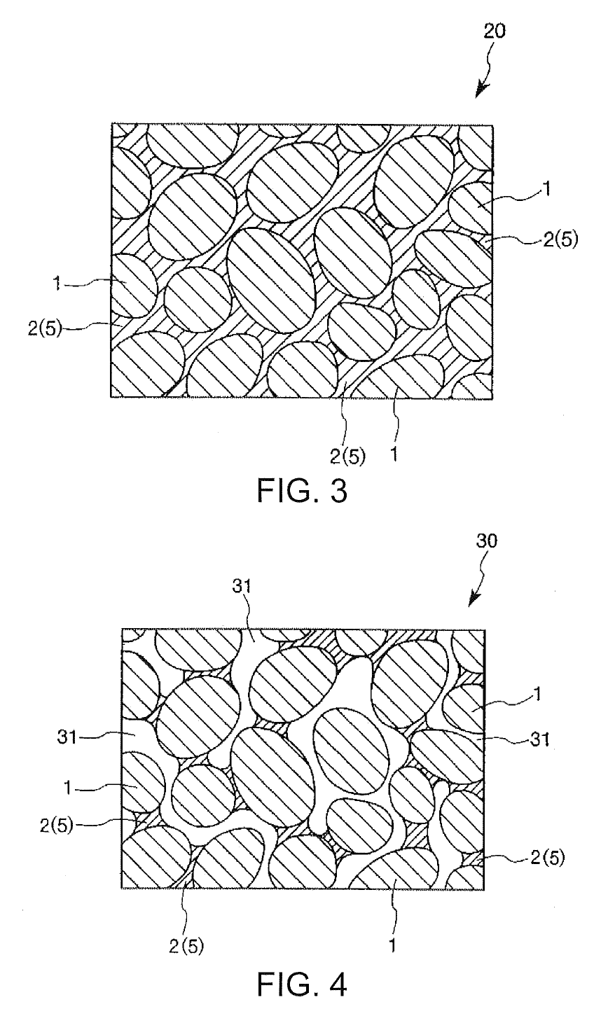

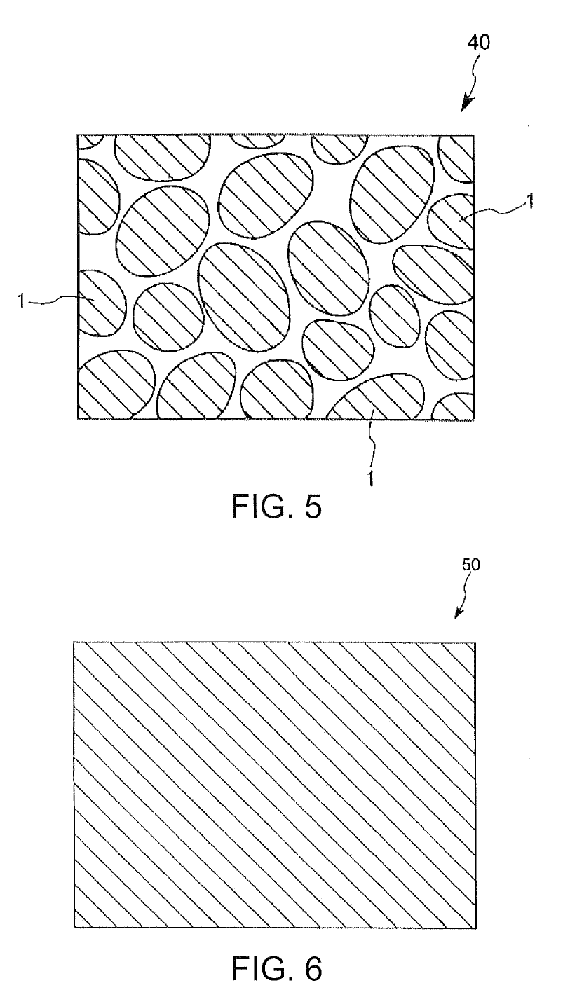

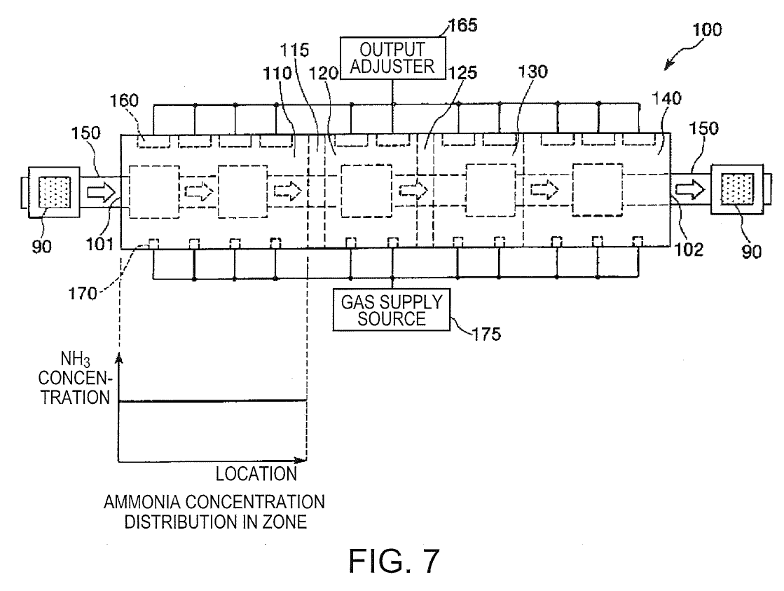

FIG. 3 is a longitudinal sectional view schematically showing a compact obtained in the first embodiment, and FIG. 4 is a longitudinal sectional view schematically showing a first degreased body obtained in the first embodiment. FIG. 5 is a longitudinal sectional view schematically showing a second degreased body obtained in the first embodiment. Further, FIG. 6 is a longitudinal sectional view showing schematically showing a sintered body according to the first embodiment, while FIG. 7 is a plan view schematically showing a continuous furnace used in the first embodiment.

A method for producing the sintered body shown in FIG. 1 includes: [A] a compact forming step by forming the composition 10 in a predetermined shape, [B] the first degreasing step to obtain the first degreased body by decomposing and removing the first resin 3 from the compact by exposing the obtained compact to an atmosphere containing a highly concentrated alkaline gas whose concentration is relatively higher than that in an intermediate step described later, [C] an intermediate step to obtain an intermediate degreased body by exposing the first degreased body obtained to an atmosphere containing a low concentrated alkaline gas whose concentration is relatively lower than that in the first degreasing step, [D] a second degreasing step to obtain the second degreased body by decomposing and removing the second resin 4 from the intermediate degreased body by heating the intermediate degreased body obtained, and [E] a sintering step to obtain the sintered body by sintering the second degreased body obtained.

Here, prior to description of the method for producing the sintered body, a furnace shown in FIG. 7 to be used for degreasing and sintering a compact will be described.

In the method for producing the sintered body according to the invention, any furnaces can be used. For example, a continuous sintering furnace for degreasing, a batch type degreasing furnace and a batch type sintering furnace or the like can be used. In the first embodiment, a case of using a continuous sintering furnace 100 for degreasing (hereinafter, abbreviated as “continuous furnace”) is described as an example.

The continuous furnace 100 shown in FIG. 7 is provided with four zones (spaces) 110, 120, 130, and 140 that are communicated with each other therein.

Each of the zones 110, 120, 130, and 140 includes a conveyer 150 continuously arranged therein to convey a workpiece 90 to be the compact, the first degreased body, the intermediate degreased body, the second degreased body and the like. That is, the continuous furnace 100 enables continuous performance of [B] the first degreasing step, [C] the intermediate step, [D] the second degreasing step, and [E] the sintering step by allowing the workpiece 90 to pass through the zones 110, 120, 130, and 140. Then, with the conveyer 150, the workpiece 90 can enter the furnace from the furnace entrance 101, and sequentially pass through the zone 110, the zone 120, the zone 130, and the zone 140, and then exit the furnace from a furnace exit 102 to be out of the furnace. This enables a plurality of the workpieces 90 to be treated at a time so as to produce sintered bodies, thereby improving production efficiency of the sintered body. Further, by using the continuous furnace 100, the workpiece 90 is prevented from being exposed to the air in the middle of producing the sintered body. Therefore, in particular, oxidation of a metal powder caused by contact of the workpiece 90 containing it with the air is reliably prevented.

In each of the zones 110, 120, 130, and 140, heaters 160 that can individually heat the workpiece 90 in each zone to be a predetermined temperature are provided. The heaters 160 are respectively connected to an output adjuster 165 that can adjust an output of the heaters 160. Then, the output adjuster 165 can cooperatively control the output of the heaters 160, enabling each of the zones having a temperature gradient formed in a predetermined pattern.

Further, each of the zones 110, 120, 130, and 140 is provided with nozzles 170 that can supply a predetermined gas to each of the zones. The nozzles 170 are arranged along a longitudinal direction of the continuous furnace 100 and connected with a gas supply source 175 by pipes. Then, various types of gases generated from the gas supply source 175 are suppliable in a predetermined flow amount to each of the zones through the nozzles 170.

Further, in the first embodiment, an alkaline gas concentration in the zone 110 is nearly constant as shown in a graph of FIG. 7.

Further, in a space between the zones 110 and 120, and a space between the zones 120 and 130, exhaust systems 115 and 125 are formed respectively so as to exhaust the gas in each of the spaces to the outside. Such an operation of the exhaust systems 115 and 125 can prevent the gases from being mixed each other between the zones 110 and 120, and between the zones 120 and 130. That is, a constitution of each of the gases is prevented from undesirably changing in each of the zones 110, 120, 130, and 140.

The continuous furnace 100 shown in FIG. 7 is in a linear shape in a plan view, however, may be inflected in the middle.

Now, each step shown in FIG. 1 will be sequentially described below.

[A] Compact Forming Step First, a kneaded product made by kneading the composition 10 or a pellet made by granulating the kneaded product is formed in a predetermined shape so as to obtain a compact 20 shown in FIG. 3.

The compact 20 is formed by employing various molding methods such as injection molding, extrusion molding, compression molding (press molding), and calendering molding, for example. A molding pressure in a case of compression molding is preferably about 5 to 100 Mpa.

Among the various molding methods as above, the compact 20 is preferably formed by the injection molding or the extrusion molding.

In the injection molding, the kneaded product or the pellet is molded by injection with an injection molding machine so as to form the compact 20 having a desired shape and dimension. In this case, by selecting a molding tool, the compact 20 can be easily formed to be even in a complex and fine shape.

Molding conditions of the injection molding vary depending on the composition or the particle diameter of the powder 1 to be used, the composition of the binder 2, the blending quantity thereof, and the like. An example of the conditions is the following: a preferable material temperature of from about 80 to about 210 degrees Celsius, and a preferable injection pressure of from about 2 to about 15 MPa (20 to 150 kgf/cm²).

In the extrusion molding, the kneaded product or the pellet is molded by extruding with an extruder, and then cut into a desired length so as to form the compact 20. In this case, by selecting a molding tool, the compact 20 can be especially easily and inexpensively formed to be in a column or plate-like shape having a desired extruded surface.

Molding conditions of the extrusion molding vary depending on the composition or the particle diameter of the powder 1 to be used, the composition of the binder 2, the blending quantity thereof, and the like. An example of the conditions is the following: a preferable material temperature of from about 80 to about 210 degrees Celsius, and a preferable extrusion pressure of from about 1 to about 10 MPa (10 to 100 kgf/cm²).

A dimension of the compact 20 to be formed is determined on the assumption of shrinkage or the like of the compact 20 in each of the degreasing step, the intermediate step, and the sintering step later.

[B] First Degreasing Step

Next, the compact 20 obtained in the compact forming step is loaded on the conveyer 150 of the continuous furnace 100 and carried to the zone 110. Then, while passing through the zone 110, the compact 20 is exposed to the atmosphere containing a highly concentrated alkaline gas whose concentration is relatively higher than that in the intermediate step described later. According to the above, by decomposing and removing the first resin 3 from the compact 20, a first degreased body 30 shown in FIG. 4 is obtained.

As described above, the first resin 3 is decomposed at a relatively low temperature by contacting the alkaline gas. Then, the decomposed matter is converted into a gas and easily and rapidly removed (degreased) from the compact 20. On the other hand, most of the second resin 4 and an additive remain in the compact 20 without being decomposed although a part of them is decomposed in this step. According to the above, the total time required for degreasing is shortened while maintaining shape retention of the first degreased body 30 obtained.

Further, at this time, the decomposed matter of the first resin 3 is exhausted from the inside of the compact 20 to the outside. Accompanied by this, an extremely small flow path 31 is formed along a trail of the decomposed matter passing through in the first degreased body 30. The flow path 31 will be a flow path for decomposed matters of the second resin 4 and the additive to be exhausted to the outside of the compact 20 in the second degreasing step to be described later. Therefore, this flow path 31 can accelerate degreasing in the second degreasing step described later.

Further, the flow path 31 is formed by the first resin 3 decomposed by contacting the alkaline gas, thereby being sequentially formed from an outer surface toward the inside of the compact 20. Therefore, the flow path 31 is inevitably communicated with an outer space, ensuring exhaust of the decomposed matters of the second resin 4 and the additive to the outside in the second degreasing step described later.

In addition to the effects above, especially in a case where the compact 20 includes a metal powder, a content rate of oxygen of the first degreased body 30 is prevented from increasing because the alkaline gas should not oxidize the metal powder.

The atmosphere containing a highly concentrated alkaline gas used in the step, as described above, has the alkaline gas concentration that is relatively higher than that of the atmosphere containing a low concentrated alkaline gas used in the intermediate step described later.

Examples of the alkaline gas include ammonia (NH₃) gas and an amine gas such as trimethylamine (CH₃)₃N.

Further, in particular, among such alkaline gasses, one containing an ammonia gas as a main constituent is preferable. An ammonia gas is favorable to be used as the alkaline gas for the embodiments because of its strong action to decompose the first resin 3.

Further, other than the alkaline gas, the atmosphere containing a highly concentrated alkaline gas can contain an inert gas such as nitrogen, helium, and argon, a reducing gas such as hydrogen, and so-called a non-oxygenated gas such as a mixed gas containing two or more of them. Among them, the atmosphere containing a highly concentrated alkaline gas preferably includes an inert gas other than the alkaline gas, more preferably includes an inert gas containing nitrogen as its main constituent. An inert gas has poor reactivity with constituent materials of the powder 1, preventing the powder 1 from altering and deteriorating due to an unwanted chemical reaction or the like. In addition, since nitrogen is relatively inexpensive, cost reduction of the first degreasing step can be achieved.

Further, the concentration of the alkaline gas in the atmosphere containing a highly concentrated alkaline gas is preferably from about 20 to about 100 vol %, and more preferably from about 30 to about 100 vol %, and further preferably from about 50 to about 100 vol %. The alkaline gas having a concentration within the range above can efficiently and securely decompose and remove the first resin 3. However, even if the concentration of the alkaline gas exceeds the upper limit described above, further increase of efficiency with decomposing of the first resin 3 by the alkaline gas cannot be expected.

Further, in the first degreasing step as the above, it is preferable that a new atmosphere containing a highly concentrated alkaline gas be supplied around the compact 20 so as to perform degreasing while the decomposed matter of the first resin 3 is exhausted. Accordingly, around the compact 20, a concentration of the decomposed gas exhausted from the compact 20 increases as the degreasing proceeds, preventing decrease of the efficiency with decomposing of the first resin 3 by the alkaline gas.

At this time, a flow amount of the gas to be supplied to the atmosphere containing a highly concentrated alkaline gas is appropriately arranged with respect to a volume of the zone 110 and not particularly limited. However, the flow amount is preferably from about 1 to about 30 m³/h, and more preferably from about 3 to about 20 m³/h.

Further, a temperature of the atmosphere containing a highly concentrated alkaline gas is preferably from about 20 to about 190 degrees Celsius, and more preferably from 70 to about 170 degrees Celsius although it may vary depending on the composition and the like of the first resin 3. The alkaline gas at a temperature within the range above can efficiently and securely decompose and remove the first resin 3. In addition, significant softening of the second resin 4 is avoided, preventing the shape retention of the first degreased body 30 from decreasing. As a result, the dimensional precision of the sintered body to be finally obtained is more securely prevented from decreasing.

Further, in particular, when the first resin 3 includes an aliphatic carbonic acid ester based resin as its main constituent, a temperature of an atmosphere containing highly concentrated ozone is preferably from about 50 to about 190 degrees Celsius, and more preferably from 70 to about 170 degrees Celsius.

Further, in particular, when the first resin 3 includes a polyhydroxycarboxylic acid based resin as its main constituent, a temperature of the atmosphere containing highly concentrated ozone is preferably from about 50 to about 180 degrees Celsius, and more preferably from about 70 to about 170 degrees Celsius.

Further, time for the first degreasing step is appropriately arranged with respect to a content rate of the first resin 3, the temperature of the atmosphere containing a highly concentrated alkaline gas, and the like, and not particularly limited. However, it is preferably from about 1 to about 30 hours, and more preferably from about 3 to about 20 hours. According to the above, the first resin 3 can be efficiently and securely decomposed and removed.

[C] Intermediate Step

Next, the first degreased body 30 obtained in the first degreasing step is carried to the zone 120 by the conveyer 150. Then, while passing through the zone 120, the first degreased body 30 is exposed to the atmosphere containing a low concentrated alkaline gas whose concentration is lower than that of the atmosphere containing a highly concentrated alkaline gas.

Here, the first degreased body 30 after the first degreasing step has an atmosphere gas containing a highly concentrated alkaline gas whose concentration is high remaining in the flow path 31 having been formed. The alkaline gas decomposes by breaking a bond of the first resin 3 because of its reducing action. However, when a gas (e.g. ammonia) containing nitrogen atom is used as the alkaline gas, nitriding of the inorganic material may be caused depending on a composition of the inorganic material powder contained in the first degreased body 30. In particular, when the first degreased body 30 proceeds to the second degreasing step or the sintering step while the highly concentrated alkaline gas is remaining in the flow path 31, progression of nitriding of the inorganic material becomes more remarkable due to heat application.

When the inorganic material is nitrided, there is concern that characteristics (e.g. mechanical characteristics, electrical characteristics, and chemical characteristics) of the sintered body to be finally obtained may be decreased. In particular, there is a possibility that mechanical characteristics are decreased accompanied with the effect of nitride.

Therefore, in the first embodiment, the intermediate step for exposing the first degreased body 30 to the atmosphere containing a low concentrated alkaline gas is performed.

In the intermediate step, the atmosphere gas containing a highly concentrated alkaline gas remaining in the flow path 31 is substituted by an atmosphere gas containing a low concentrated alkaline gas (or a gas without containing an alkaline gas). Accordingly, contact frequency of the inorganic material and the alkaline gas in the first degreased body 30 is reduced, preventing the inorganic material from being nitrided. Consequently, a sintered body that is particularly superior in various characteristics is obtained.

Here, an alkaline gas concentration of the atmosphere containing a low concentrated alkaline gas should be lower than that of the atmosphere containing a highly concentrated alkaline gas. However, it is preferable to be as low as possible.

Specifically, although the alkaline gas concentration of the atmosphere containing a low concentrated alkaline gas varies depending on the alkaline gas concentration of the atmosphere containing a highly concentrated alkaline gas, it is preferably less than 20 vol %, and more preferably less than 10 vol %.

Further, it is more preferable that the atmosphere containing a low concentrated alkaline gas do not substantially contain an alkaline gas. Accordingly, the alkaline gas is removed more or less from the flow path 31, more securely preventing the inorganic material from being nitrided.

Further, other than the alkaline gas, the atmosphere containing a low concentrated alkaline gas can contain an inert gas such as nitrogen, helium, and argon, a reducing gas such as hydrogen, and so-called a non-oxygenated gas such as a mixed gas containing two or more of them. In particular, it is preferable to contain the non-oxygenated gas as a main constituent. According to the above, while the inorganic material is prevented from being nitrided, the inorganic material, in particular, a metal material can be prevented from oxidizing.

At this time, a flow amount of the atmosphere containing a low concentrated alkaline gas to be supplied is appropriately arranged with respect to a volume of the zone 120 and not particularly limited. However, the flow amount is preferably from about 0.5 to about 30 m³/h, and more preferably from about 1 to about 20 m³/h.

Further, it is preferable that a temperature of the atmosphere containing a low concentrated alkaline gas be lower than that of the atmosphere containing a highly concentrated alkaline gas in the first degreasing step. Accordingly, the reducing action of the alkaline gas of the atmosphere containing a low concentrated alkaline gas in the flow path 31 is further reduced, and the inorganic material in the first degreased body 30 is more securely prevented from being nitrided.

More specifically, a temperature of the atmosphere containing a low concentrated alkaline gas is preferably from about 10 to about 180 degrees Celsius, and more preferably from about 30 to about 120 degrees Celsius although it may vary depending on the temperature of the atmosphere containing a highly concentrated alkaline gas. According to the above, the reducing action of the alkaline gas of the atmosphere containing a low concentrated alkaline gas is more securely suppressed, while the first degreased body 30 is prevented from receiving a rapid temperature change.

Further, it is desirable that the time for the first degreasing step be as long as possible, but it is preferably about 0.1 to about 5 hours, more preferably about 0.5 to about 3 hours. Accordingly, the highly concentrated alkaline gas remaining in the flow path 31 is sufficiently substituted by the atmosphere gas containing a low concentrated alkaline gas.

As the above, the intermediate degreased body formed by substituting the highly concentrated alkaline gas remaining in the flow path 31 of the first degreased body 30 by the atmosphere gas containing a low concentrated alkaline gas is obtained.

However, this step is conducted according to need, so that it may be omitted. In this case, the degreased body will be obtained by going through the first degreasing step and the second degreasing step to be described later.

[D] Second Degreasing Step

Next, the intermediate degreased body obtained in the intermediate step is carried to the zone 130 by the conveyer 150. The intermediate degreased body is heated while passing through the zone 130. According to the above, the second resin 4 and the additive (e.g. the dispersants 5) are decomposed and removed from the intermediate degreased body, providing a second degreased body 40 as shown in FIG. 5.

The second resin 4 (and the additive) decomposed by heat application is exhausted to outside of the intermediate degreased body through the flow path 31 formed in the first degreasing step, being easily and rapidly degreased. Accordingly, the second resin 4 and the additive are prevented from remaining in large amounts inside the second degreased body 40. That is, the degreasing is performed through the flow path 31, preventing the decomposed matters of the second resin 4 and the additive from being enclosed inside the intermediate degreased body. Therefore, deformation and cracks occurring to the second degreased body 40 is securely prevented and degreasing efficiency becomes high, thereby shortening the total time required for the degreasing steps. As a result, the second degreased body 40 and the sintered body being superior in characteristics such as dimensional precision and mechanical strength are efficiently obtained.

The flow path 31 in the intermediate degreased body may disappear during the sintering step described later, or even if it remains, it may be as an extremely minute pore. Therefore, the sintered body to be obtained has a particularly high density. Further, the sintered body to be obtained will hardly have problems such as poor aesthetic appearance, low mechanical strength, or the like.

The atmosphere in which this step (the second degreasing step) is conducted is not particularly limited, but may be a reducing atmosphere such as hydrogen, an inert atmosphere such as nitrogen, helium, and argon, a reduced-pressure atmosphere (vacuum) and the like.

In particular, the atmosphere in which this step is conducted preferably contains a reducing gas as a main constituent. Although this step is conducted under an atmosphere at a relatively high temperature, if the atmosphere includes a reducing gas as a main constituent, especially the metal material in the intermediate degreased body is securely prevented from oxidizing.

Further, the temperature of the atmosphere should be higher than the temperature of the atmosphere in the first degreasing step, and it slightly differs depending on compositions of the second resin 4 and the additive. However, it is preferably in a range from about 190 to about 600 degrees Celsius, and more preferably in a range from about 250 to about 550 degrees Celsius. Under the atmosphere at the temperature within the ranges above, the second resin 4 and the additive are efficiently and securely decomposed and removed. On the contrary, if the temperature of the atmosphere is less than the lower limit, the efficiency of decomposing and removing the second resin 4 and the additive may be reduced. Further, even if the temperature of the atmosphere is more than the upper limit, a speed of decomposing and removing the second resin 4 and the additive is hardly improved, so that it is not efficient.

Further, time for the second degreasing step is appropriately arranged with respect to the compositions and content rates of the second resin 4 and the additive, and the temperature of the atmosphere and the like, and not particularly limited. However, it is preferably from about 0.5 to about 10 hours, and more preferably from about 1 to about 5 hours. According to the above, the second resin 4 and the additive can be efficiently and securely decomposed and removed (decreased).

However, this step is conducted according to need, so that it may also be omitted if the composition 10 does not contain the second resin 4 and the additive, for example. In this case, the degreased body will be obtained by going through the first degreasing step and the intermediate step. Further, if the intermediate step is also omitted, the degreased body will be obtained through the first degreasing step.

[E] Sintering Step

Next, the second degreased body 40 obtained in the second degreasing step is carried to the zone 140 by the conveyer 150. Then, the second degreased body 40 is heated while passing through the zone 140.

When the second degreased body 40 is heated, grain growth of the powder 1 inside thereof occurs by mutual dispersion at an interface of ones contacting each other, forming crystal grain. As a result, a sintered body 50 that is dense as a whole, that is, having a high density and low porosity, is obtained as shown in FIG. 6.

The sintering temperature of the sintering step slightly differs depending on a composition or the like of the material composing the powder 1, but it is preferably in a range from about 900 to about 1800 degrees Celsius, and more preferably in a range from about 1000 to about 1700 degrees Celsius. At the sintering temperature within the ranges above, dispersion and grain growth of the powder 1 are optimized, providing the sintered body 50 having superior characteristics (mechanical strength, dimensional precision, appearance, and the like).

Further, the sintering temperature of the sintering step can temporally vary (increase or decrease) within or out of the ranges above.

The sintering time is preferably from about 0.5 to about 7 hours, more preferably from about 1 to about 4 hours.

The atmosphere in which the sintering step is conducted is appropriately selected also with respect to a composition of the inorganic material composing the powder 1, and is not particularly limited. However, it may be a reducing atmosphere such as hydrogen, an inert atmosphere such as nitrogen, helium, and argon, a reduced-pressure atmosphere reducing pressure of the atmosphere described above, or a pressurized atmosphere by pressurizing, or the like.

Among them, it is preferable that the atmosphere for the sintering step be the reduced-pressure atmosphere. Under the reduced-pressure atmosphere, especially the metal material in the second degreased body 40 is sintered without being oxidized. In addition, since an evacuation pump to form the reduced-pressure atmosphere is not required, a running cost for the sintering step can be reduced.

In a case of the reduced-pressure atmosphere, the pressure is not particularly limited, but it is preferably 3 kPa (22.5 Torr) or less, and more preferably 2 kPa (15 Torr) or less.

Further, in a case of the pressurized atmosphere, the pressure is also not particularly limited, but it is preferably from about 110 to about 1500 kPa, and more preferably from about 200 to about 1000 kPa.

In addition, the atmosphere for the sintering step can be changed during the sintering step. For example, first a reduced-pressure atmosphere of about 3 kPa is employed, then it can be changed to the inert atmosphere as described above in the middle of the sintering step.

Further, the sintering step can be divided into two or more steps to be conducted. Accordingly, efficiency in sintering the powder 1 is improved, thereby enabling the sintering with a shorter time.

In addition, it is preferable that the sintering step be sequentially conducted with the second degreasing step. Accordingly, the second degreasing step can double as a presintering step and thus the second degreased body 40 is preheated, thereby more securely sintering the powder 1.

As the above, the sintered body having excellent characteristics (dimensional precision, mechanical characteristics, appearance, and the like) is securely and easily produced at a low cost.

### Second Embodiment

Next, a method for producing a degreased body and a sintered body according to a second embodiment will be described.

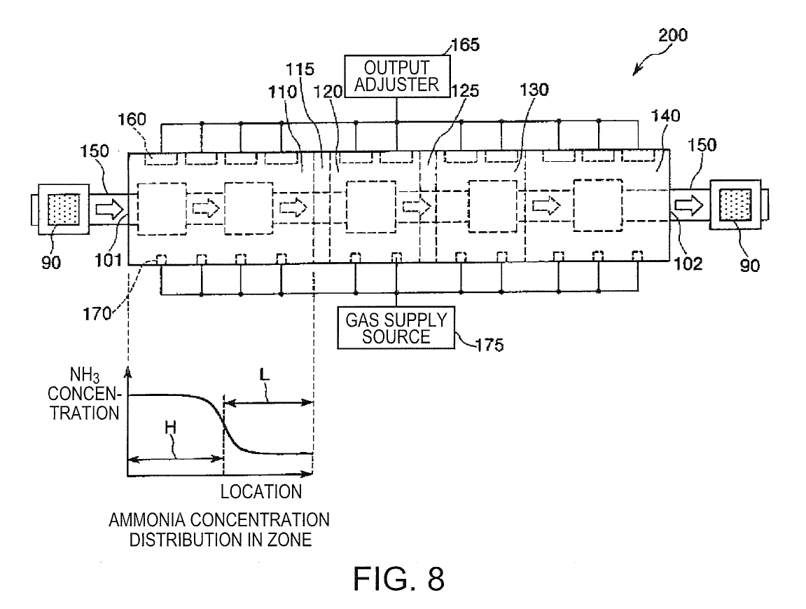

FIG. 8 is a plan view schematically showing a continuous furnace used in the second embodiment.

Now, the second embodiment will be described below. In the description, differences from the first embodiment will be mainly explained, and the same contents of them are omitted.

The method for producing a sintered body according to the second embodiment is the same as that in the first embodiment except for setting of an atmosphere of the continuous furnace to be used.

That is, in a continuous furnace 200 shown in FIG. 8, an alkaline gas concentration is continuously changed along a traveling direction of the workpiece 90 in the zone 110.

A graph in FIG. 8 shows a distribution of the alkaline gas concentration in the zone 110. As shown in the graph, the alkaline gas concentration in the zone 110 is reduced toward a front of the traveling direction of the workpiece 90 from the middle. That is, the zone 110 is divided into a region H and a region L. The region H is located in a furnace entrance side and has an atmosphere containing a highly concentrated alkaline gas whose concentration is relatively high, while the region L is located in a zone 120 side and has an atmosphere containing a low concentrated alkaline gas whose concentration is lower than that of the atmosphere containing a highly concentrated alkaline gas.

In order to grade alkaline gas concentration in the zone 110 as the above, among the nozzles 170 formed in the zone 110, nozzles corresponding to the region H and nozzles corresponding to the region L supply different types and flow amounts of gas from each other, for example.

Now, each step of the method for producing a sintered body according to the second embodiment employing the continuous furnace 200 as the above will be sequentially described.

[A] Compact Forming Step

First, similarly to the first embodiment, the compact 20 as shown in FIG. 3 is obtained.

[B] First Degreasing Step

Next, the compact 20 obtained in the compact forming step is loaded on the conveyer 150 of the continuous furnace 200 and carried to the zone 110. Then, while passing through the region H in the zone 110, the compact 20 is exposed to the atmosphere containing a highly concentrated alkaline gas. According to the above, similarly to the first embodiment, the first resin 3 is decomposed and removed from the compact 20, providing the first degreased body 30 as shown in FIG. 4.

[C] Intermediate Step (First Time)

Next, the first degreased body 30 obtained in the first degreasing step is carried to the region L in the zone 110 by the conveyer 150. Then, while passing through the region L, the first degreased body 30 is exposed to the atmosphere containing a low concentrated alkaline gas. As the above, similarly to the first embodiment, the atmosphere gas containing a highly concentrated alkaline gas remaining in the flow path 31 of the first degreased body 30 is substituted by the atmosphere gas containing a low concentrated alkaline gas.

[C] Intermediate Step (Second Time)

Next, the first degreased body 30 after the first intermediate step is carried to the zone 120 by the conveyer 150. Then, while passing through the zone 120, the first degreased body 30 is exposed to the atmosphere substantially not containing an alkaline gas. Accordingly, an intermediate degreased body is obtained after almost all of the alkaline gas remaining in the flow path 31 of the first degreased body 30 is removed.

[D] Second Degreasing Step

Next, the intermediate degreased body obtained in the intermediate step is carried to the zone 130 by the conveyer 150. Then, the intermediate degreased body is heated while passing through the zone 130. According to the above, similarly to the first embodiment, the second resin 4 and the additive (e.g. the dispersants 5) are decomposed and removed from the intermediate degreased body, providing the second degreased body 40 as shown in FIG. 5.

[E] Sintering Step

Next, the second degreased body 40 obtained in the second degreasing step is carried to the zone 140 by the conveyer 150. Then, the second degreased body 40 is heated while passing through the zone 140. According to the above, similarly to the first embodiment, the second degreased body 40 is sintered, providing the sintered body 50 as shown in FIG. 6.

In the second embodiment, the first degreasing step and the intermediate step are sequentially conducted in a single zone that is the zone 110. According to the above, the atmosphere in the zone 110 is continuously changed from the atmosphere containing a highly concentrated alkaline gas to the atmosphere containing a low concentrated alkaline gas. At this time, in the compact 20, the powder 1 made of the inorganic material that has been covered with the first resin 3 is gradually exposed as the first resin 3 having been exposed to the atmosphere containing a highly concentrated alkaline gas is decomposed and removed. Then, accompanied with this exposure, the powder 1 is gradually exposed to the alkaline gas.

However, in the second embodiment, an atmosphere in the zone 110 is arranged so as to be changed from the atmosphere containing a highly concentrated alkaline gas to the atmosphere containing a low concentrated alkaline, suppressing exposure frequency of the powder 1 to the alkaline gas. Thus the metal material composing the powder 1 can be especially prevented from oxidizing.

Further, the first degreasing step and the intermediate step are sequentially conducted in the single zone that is the zone 110, thereby further shortening time required for conducting these steps.

In addition, conduction of the intermediate degreasing divided into two steps can make the alkaline gas remaining in the flow path 31 of the first degreased body 30 securely removed.

In the method for producing a sintered body according to the second embodiment, the same performance and advantages as those in the first embodiment can also be obtained.

### Third Embodiment

Next, a method for producing a degreased body and a sintered body according to a third embodiment will be described.

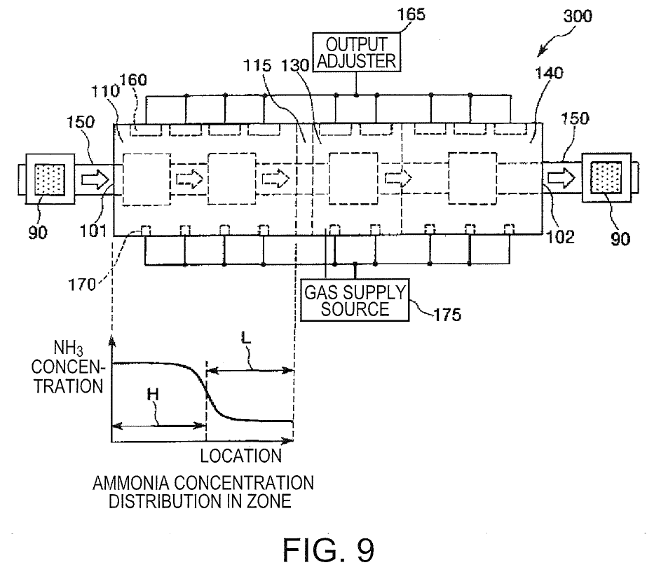

FIG. 9 is a plan view schematically showing a continuous furnace used in the third embodiment.

Now, the third embodiment will be described below, however, in the description, differences from the first and second embodiments will be mainly explained, and the same contents of them are omitted.

The method for producing a sintered body according to the third embodiment is the same as that in the second embodiment except for a structure of the continuous furnace to be used.

A continuous furnace 300 shown in FIG. 9 is provided with three zones (spaces) 110, 130, and 140 that are communicated with each other therein. That is, the continuous furnace 300 shown in FIG. 9 is structured by omitting the zone 120 among the zones 110, 120, 130, and 140 of the continuous furnace 200 shown in FIG. 8.

Similarly to the first embodiment, each of the zones 110, 130, and 140 is provided with the conveyer 150.

Further, each of the zones 110, 130, and 140 is individually provided with a plurality of heaters 160 and a plurality of nozzles 170 therein, similarly to the continuous furnaces shown in FIGS. 7 and 8. Further, each of the heaters 160 is connected to the output adjuster 165, while each of the nozzles 170 is connected to the gas supply source 175.

Here, in the third embodiment, an alkaline gas concentration is continuously changed along the traveling direction of the workpiece 90 in the zone 110, similarly to the zone 110 shown in FIG. 8.

A graph in FIG. 9 shows a distribution of the alkaline gas concentration in the zone 110. As shown in the graph, similarly to the zone 110 shown in FIG. 8, the alkaline gas concentration in the zone 110 is reduced toward the front of the traveling direction of the workpiece 90 from the middle. That is, the zone 110 is divided into the region H and the region L. The region H has an atmosphere containing a highly concentrated alkaline gas, while the region L has an atmosphere containing a low concentrated alkaline gas.

Now, each step of the method for producing a sintered body according to the third embodiment employing the continuous furnace 300 as the above will be sequentially described.

[A] Compact Forming Step

First, similarly to the first and second embodiments, the compact 20 as shown in FIG. 3 is obtained.

[B] First Degreasing Step

Next, the compact 20 obtained in the compact forming step is loaded on the conveyer 150 of the continuous furnace 300 and carried to the zone 110. Then, while passing through the region H in the zone 110, the compact 20 is exposed to the atmosphere containing a highly concentrated alkaline gas. According to the above, similarly to the first and second embodiments, the first resin 3 is decomposed and removed from the compact 20, providing the first degreased body 30 as shown in FIG. 4.

[C] Intermediate Step

Next, the first degreased body 30 obtained in the first degreasing step is carried to the region L in the zone 110 by the conveyer 150. Then, while passing through the region L, the first degreased body 30 is exposed to the atmosphere containing a low concentrated alkaline gas. As the above, similarly to the first and second embodiments, the atmosphere gas containing a highly concentrated alkaline gas remaining in the flow path 31 of the first degreased body 30 is substituted by the atmosphere gas containing a low concentrated alkaline gas, providing the intermediate degreased body.

[D] Second Degreasing Step

Next, the intermediate degreased body obtained in the intermediate step is carried to the zone 130 by the conveyer 150. Then, the intermediate degreased body is heated while passing through the zone 130. According to the above, similarly to the first and second embodiments, the second resin 4 and the additive (e.g. the dispersants 5) are decomposed and removed from the intermediate degreased body, providing the second degreased body 40 as shown in FIG. 5.

[E] Sintering Step

Next, the second degreased body 40 obtained in the second degreasing step is carried to the zone 140 by the conveyer 150. Then, the second degreased body 40 is heated while passing through the zone 140. According to the above, similarly to the first and second embodiments, the second degreased body 40 is sintered, providing the sintered body 50 as shown in FIG. 6.

In the method for producing a sintered body according to the third embodiment as the above, the same performance and advantages as those in the first and second embodiments can also be obtained.

In the above, the preferred embodiments of the method for producing a sintered body and the sintered body have been described. However, the invention is not limited to those embodiments.

For example, arbitrary steps can be also added to the method for producing a sintered body according to need.

### EXAMPLES

Specific examples of the invention will now be described.

1. Compact Forming

In the following, a predetermined number of compacts of each sample number were formed.

[Sample No. 1]

A SUS316L powder formed by water atomization and polypropylene carbonate (a weight average molecular weight: 50000) were mixed, and kneaded with a pressure kneader under the following kneading conditions.

An average particle diameter of the SUS316L powder was 10 μm.

The mixing ratio between the powder and the other components (a binder and an additive) was 93:7 in weight ratio.

<Kneading Conditions>

Kneading temperature: 200 degrees Celsius

Kneading time: 0.75 hours

Atmosphere: nitrogen gas

The kneaded product was crushed to be a pellet having an average particle diameter of 3 mm. Then injection molding using the pellet was repeatedly conducted with an injection molding machine under the following molding conditions so as to form a predetermined number of compacts of Sample No. 1.

Here, the compacts were formed to be in a cubical shape of 15×15×15 mm. Each of the compacts has a through hole of which an inside diameter is 5 mm at the center part of two surfaces facing each other.

<Molding Conditions>

Temperature of material: 210 degrees Celsius

Injecting pressure: 10.8 MPa (110 kgf/cm²)

[Samples No. 2 through 12]

Compacts of each of Sample No. 2 through 12 were formed in the same manner as Sample No. 1 except for changing the mixing ratio of the components other than the powder and a composition of the binder as shown in Table 1.

[Samples No. 13 and 14]

Compacts of each of Sample No. 13 and 14 were formed in the same manner as Sample No. 1 except for changing the composition of the inorganic material powder to zirconia and arranging a composition of the binder as shown in Table 1.

[Samples No. 15 and 16]

Compacts of each of Sample No. 15 and 16 were formed in the same manner as Sample No. 1 except for changing the composition of the inorganic material powder to silicon nitride and arranging the composition of the binder as shown in Table 1.

[Samples No. 17 and 18]

Compacts of each of Sample No. 17 and 18 were formed in the same manner as the sample No. 1 except for not adding the first resin to the binder and arranging the composition of the second resin and the additive as shown in Table 1.

TABLE 1

| | | | | Composition and mixing ratio of components other than | | | | | | |
|---|---|---|---|---|---|---|---|---|---|---|
| | | Mixing ratio between | | inorganic material (weight ratio) | | | | | | |
| | | inorganic material | | Binder | | | | | | |
| | | powder and | | First resin | | | | | | |
| | | components other | | | | Polyhydroxy- | | | | |
| | | than inorganic | | Aliphatic | | carboxylic | | | | |
| | | material powder | | carbonic acid | | acid based | | | | |
| | | (weight ratio) | | ester based resin | | resin | | | | |
| | | | Components | Poly- | Poly- | Poly-L- | Poly- | Second resin | | |
| | | | other than | propylene | ethylene | lactic | glycolic | Poly- | Poly- | |
| | Composition of | Inorganic | inorganic | carbonate | carbonate | acid | acid | styrene | ethylene | additive |
| Sample | inorganic material | material | material | (Mw: | (Mw: | (Mw: | (Mw: | (Mw: | (Mw: | Stearic |
| No. | powder | powder | powder | 50,000) | 50,000) | 150,000) | 150,000) | 10,000) | 300,000) | acid |
| 1 | SUS316L | 93 | 7 | 100 | — | — | — | — | — | — |
| 2 | SUS316L | 93 | 7 | — | 100 | — | — | — | — | — |
| 3 | SUS316L | 93 | 7 | 75 | 25 | — | — | — | — | — |
| 4 | SUS316L | 93 | 7 | 90 | — | — | — | 10 | — | — |
| 5 | SUS316L | 93 | 7 | 90 | — | — | — | — | 10 | — |
| 6 | SUS316L | 93 | 7 | 90 | — | — | — | 5 | 5 | — |
| 7 | SUS316L | 93 | 7 | 90 | — | — | — | 9 | — | 1 |
| 8 | SUS316L | 93 | 7 | 50 | — | — | — | 50 | — | — |
| 9 | SUS316L | 93 | 7 | 20 | — | — | — | 75 | — | 5 |
| 10 | SUS316L | 93 | 7 | 15 | — | — | — | 80 | — | 5 |
| 11 | SUS316L | 93 | 7 | 30 | — | 50 | — | 19 | — | 1 |
| 12 | SUS316L | 93 | 7 | 30 | — | — | 50 | 19 | — | 1 |
| 13 | Zirconia | 84 | 16 | 100 | — | — | — | — | — | — |
| 14 | Zirconia | 84 | 16 | 90 | — | — | — | 9 | — | 1 |
| 15 | Silicon | 76 | 24 | 100 | — | — | — | — | — | — |
| | nitride | | | | | | | | | |
| 16 | Silicon | 76 | 24 | 50 | — | — | — | 50 | — | — |
| | nitride | | | | | | | | | |
| 17 | SUS316L | 93 | 7 | — | — | — | — | 95 | — | 5 |
| 18 | SUS316L | 93 | 7 | — | — | — | — | 50 | 50 | — |

Samples No. 1 to 16: Examples
Samples No. 17 and 18: Comparative examples
Mw: weight average molecular weight

2. Sintered Body Forming

### Example 1

The first degreasing step was next conducted to the compacts of Sample No. 1 with the continuous furnace as shown in FIG. 7 under the following conditions so as to obtain degreased bodies.

<Conditions of First Degreasing Step>

Temperature: 150 degrees Celsius

Time: 6 hours

Atmosphere: nitrogen gas containing an ammonia gas (alkaline gas) (concentration of the ammonia gas: 75 vol %)

The degreased bodies that had been obtained were sintered with the continuous furnace under the following conditions as the sintering step so as to obtain sintered bodies.

<Conditions of Sintering Step>

Temperature: 1350 degrees Celsius

Time: 3 hours

Atmosphere: hydrogen gas (atmospheric pressure)

### Examples 2 through 16

Sintered bodies were obtained in the same manner as the example 1 except for setting the sample number of the compact that was used, conditions of the first degreasing step, and conditions of the sintering step as shown in Table 2, and conducting the intermediate step between the first degreasing step and the sintering step under the following conditions.

<Conditions of Intermediate Step>

Temperature: 100 degrees Celsius (30 degrees Celsius in Example

Time: 1 hour

Atmosphere: nitrogen gas (nitrogen gas containing an ammonia gas in Examples 9 and 10)

### Examples 17 through 27

Sintered bodies were obtained in the same manner as Example 5 except for setting the sample number of the compact that was used and conditions of the sintering step as shown in Table 2, and conducting the second degreasing step between the intermediate step and the sintering step under the following conditions.

<Conditions of Second Degreasing Step>

Temperature: 500 degrees Celsius

Time: 1 hour (2 hours in Examples 22 and 23)

Atmosphere: hydrogen gas

### Example 28

Sintered bodies were obtained in the same manner as Example 17 except for omitting the intermediate step.

### Example 29

Sintered bodies were obtained in the same manner as Example 17 except for using the continuous furnace as shown in FIG. 8, and setting a nitrogen gas containing an ammonia gas in the zone for conducting the first degreasing step in the continuous furnace so as to decrease the concentration of the ammonia gas from 75 vol % to 5 vol % continuously.

### Example 30

Sintered bodies were obtained in the same manner as Example 17 except for using the continuous furnace as shown in FIG. 9, setting a nitrogen gas containing an ammonia gas in the zones for conducting the first degreasing step and the intermediate step in the continuous furnace so as to decrease the concentration of the ammonia gas from 75 vol % to 5 vol % continuously, and conducting the first degreasing step and the intermediate step successively by letting the compact through the zones.

### Comparative Example 1

Sintered bodies were obtained in the same manner as Example 1 except for changing the concentration of the ammonia gas to 0 vol %, and changing the time for the first degreasing step to 20 hours.

### Comparative Example 2

Sintered bodies were obtained in the same manner as Example 1 except for changing the concentration of the ammonia gas to 0 vol %, and changing the time for the first degreasing step to 80 hours.

### Comparative Examples 3 and 4

Sintered bodies were obtained in the same manner as Comparative Examples 1 and 2 except for conducting the intermediate step between the first degreasing step and the sintering step under the following conditions.

<Conditions of Intermediate Step>

Temperature: 100 degrees Celsius

Time: 1 hour

Atmosphere: nitrogen gas

### Comparative Example 5

Sintered bodies were obtained in the same manner as Example 1 except for changing the atmosphere in the first degreasing step to an atmosphere of a nitrogen gas containing 1000 ppm of ozone.

### Comparative Examples 6 and 7

Sintered bodies were obtained in the same manner as Example 17 except for changing the sample number of the compact that was used and the conditions of the second degreasing step as shown in Table 2.

3. Evaluation

3-1. Evaluation on Weight Reduction Rate

A weight reduction rate after the first degreasing step was measured on each of Examples 1 to 30 and Comparative examples 1 to 7.

A weight reduction rate after the second degreasing step was also measured on each of Examples 17 to 30 and Comparative Examples 6 and 7.

The weight reduction rate was measured in such a way that a weight of each workpiece was measured before and after each step with an electronic balance so as to calculate a rate of reduced weight.

Table 2 shows a weight reduction rate calculated on each of the examples and the comparative examples in whole of the degreasing step; a removing rate, calculated from the weight reduction rate, of components (a binder and an additive) other than the inorganic material powder; and time required for a whole of the degreasing steps.

TABLE 2

| | | Production conditions | | | |
|---|---|---|---|---|---|
| | | First degreasing step | | | |
| | | | | | Ammonia |
| | | Temperature | Time | | Concentration |
| | Sample No. | [° C.] | [hour] | Atmosphere | [vol %] |
| Example 1 | 1 | 150 | 6 | NH₃/N₂ | 75 |
| Example 2 | 1 | 150 | 20 | NH₃/N₂ | 15 |
| Example 3 | 1 | 150 | 10 | NH₃/N₂ | 20 |
| Example 4 | 1 | 150 | 8 | NH₃/N₂ | 50 |
| Example 5 | 1 | 150 | 6 | NH₃/N₂ | 75 |
| Example 6 | 1 | 150 | 5 | NH₃/N₂ | 80 |
| Example 7 | 1 | 150 | 4 | NH₃/N₂ | 90 |
| Example 8 | 1 | 150 | 4 | NH₃/N₂ | 100 |
| Example 9 | 1 | 150 | 4 | NH₃/N₂ | 100 |
| Example 10 | 1 | 150 | 4 | NH₃/N₂ | 100 |
| Example 11 | 1 | 50 | 15 | NH₃/N₂ | 75 |
| Example 12 | 1 | 190 | 4 | NH₃/N₂ | 75 |
| Example 13 | 13 | 150 | 6 | NH₃/N₂ | 75 |
| Example 14 | 15 | 150 | 6 | NH₃/N₂ | 75 |
| Example 15 | 2 | 150 | 5 | NH₃/N₂ | 80 |
| Example 16 | 3 | 150 | 5 | NH₃/N₂ | 80 |
| Example 17 | 4 | 150 | 6 | NH₃/N₂ | 75 |
| Example 18 | 5 | 150 | 6 | NH₃/N₂ | 75 |
| Example 19 | 6 | 150 | 6 | NH₃/N₂ | 75 |
| Example 20 | 7 | 150 | 6 | NH₃/N₂ | 75 |
| Example 21 | 8 | 150 | 6 | NH₃/N₂ | 75 |
| Example 22 | 9 | 150 | 6 | NH₃/N₂ | 75 |
| Example 23 | 10 | 150 | 6 | NH₃/N₂ | 75 |
| Example 24 | 11 | 130 | 6 | NH₃/N₂ | 75 |
| Example 25 | 12 | 130 | 6 | NH₃/N₂ | 75 |
| Example 26 | 14 | 150 | 6 | NH₃/N₂ | 75 |
| Example 27 | 16 | 150 | 6 | NH₃/N₂ | 75 |
| Example 28 | 4 | 150 | 6 | NH₃/N₂ | 75 |
| Example 29 | 4 | 150 | 6 | NH₃/N₂ | 75→5 |
| Example 30 | 4 | 150 | 6 | NH₃/N₂ | 75→0 |
| Comparative | 1 | 150 | 20 | N₂ | 0 |
| Example 1 | | | | | |
| Comparative | 1 | 150 | 80 | N₂ | 0 |
| Example 2 | | | | | |
| Comparative | 1 | 150 | 20 | N₂ | 0 |
| Example 3 | | | | | |
| Comparative | 1 | 150 | 80 | N₂ | 0 |
| Example 4 | | | | | |
| Comparative | 1 | 150 | 6 | O₃/N₂ | 1000 * 1 |
| Example 5 | | | | | |
| Comparative | 17 | 150 | 6 | NH₃/N₂ | 75 |
| Example 6 | | | | | |
| Comparative | 18 | 150 | 6 | NH₃/N₂ | 75 |
| Example 7 | | | | | |

| | | Production conditions | | | | | | |
|---|---|---|---|---|---|---|---|---|
| | | Intermediate step | | | | | | |
| | | | | | Ammonia | Second degreasing step | | |
| | Sample | Temperature | Time | | Concentration | Temperature | Time | |
| | No. | [° C.] | [hour] | Atmosphere | [vol %] | [° C.] | [hour] | Atmosphere |
| Example 1 | 1 | — | — | — | — | — | — | — |
| Example 2 | 1 | 100 | 1 | N₂ | 0 | — | — | — |
| Example 3 | 1 | 100 | 1 | N₂ | 0 | — | — | — |
| Example 4 | 1 | 100 | 1 | N₂ | 0 | — | — | — |
| Example 5 | 1 | 100 | 1 | N₂ | 0 | — | — | — |
| Example 6 | 1 | 100 | 1 | N₂ | 0 | — | — | — |
| Example 7 | 1 | 100 | 1 | N₂ | 0 | — | — | — |
| Example 8 | 1 | 100 | 1 | N₂ | 0 | — | — | — |
| Example 9 | 1 | 100 | 1 | NH₃/N₂ | 5 | — | — | — |
| Example 10 | 1 | 100 | 1 | NH₃/N₂ | 15 | — | — | — |
| Example 11 | 1 | 30 | 1 | N₂ | 0 | — | — | — |
| Example 12 | 1 | 100 | 1 | N₂ | 0 | — | — | — |
| Example 13 | 13 | 100 | 1 | N₂ | 0 | — | — | — |
| Example 14 | 15 | 100 | 1 | N₂ | 0 | — | — | — |
| Example 15 | 2 | 100 | 1 | N₂ | 0 | — | — | — |
| Example 16 | 3 | 100 | 1 | N₂ | 0 | — | — | — |
| Example 17 | 4 | 100 | 1 | N₂ | 0 | 500 | 1 | H₂ |
| Example 18 | 5 | 100 | 1 | N₂ | 0 | 500 | 1 | H₂ |
| Example 19 | 6 | 100 | 1 | N₂ | 0 | 500 | 1 | H₂ |
| Example 20 | 7 | 100 | 1 | N₂ | 0 | 500 | 1 | H₂ |
| Example 21 | 8 | 100 | 1 | N₂ | 0 | 500 | 1 | H₂ |
| Example 22 | 9 | 100 | 1 | N₂ | 0 | 500 | 2 | H₂ |
| Example 23 | 10 | 100 | 1 | N₂ | 0 | 500 | 2 | H₂ |
| Example 24 | 11 | 100 | 1 | N₂ | 0 | 500 | 1 | H₂ |
| Example 25 | 12 | 100 | 1 | N₂ | 0 | 500 | 1 | H₂ |
| Example 26 | 14 | 100 | 1 | N₂ | 0 | 500 | 1 | H₂ |
| Example 27 | 16 | 100 | 1 | N₂ | 0 | 500 | 1 | H₂ |
| Example 28 | 4 | — | — | — | — | 500 | 1 | H₂ |
| Example 29 | 4 | 100 | 1 | N₂ | 0 | 500 | 1 | H₂ |
| Example 30 | 4 | ← | ← | ← | ← | 500 | 1 | H₂ |
| Comparative | 1 | — | — | — | — | — | — | — |
| Example 1 | | | | | | | | |
| Comparative | 1 | — | — | — | — | — | — | — |
| Example 2 | | | | | | | | |
| Comparative | 1 | 100 | 1 | N₂ | 0 | — | — | — |
| Example 3 | | | | | | | | |
| Comparative | 1 | 100 | 1 | N₂ | 0 | — | — | — |
| Example 4 | | | | | | | | |
| Comparative | 1 | — | — | — | — | — | — | — |
| Example 5 | | | | | | | | |
| Comparative | 17 | 100 | 1 | N₂ | 0 | 500 | 5 | H₂ |
| Example 6 | | | | | | | | |
| Comparative | 18 | 100 | 1 | N₂ | 0 | 500 | 5 | H₂ |
| Example 7 | | | | | | | | |

| | | Evaluation results | | | | |
|---|---|---|---|---|---|---|
| | | First | Second | Total degreasing step | | |
| | | degreasing | degreasing | | Removing rate | |
| | | step | step | | of components | |
| | | Weight | Weight | | other than | |
| | | reduction | reduction | Weight | inorganic | |
| | | rate | rate | reduction rate | material | Required time |
| | Sample No. | [wt %] | [wt %] | [wt %] | [wt %] | [hour] |
| Example 1 | 1 | 6.94 | — | 6.94 | 99.1 | 6 |
| Example 2 | 1 | 6.74 | — | 6.74 | 96.3 | 21 |
| Example 3 | 1 | 6.90 | — | 6.90 | 98.6 | 11 |
| Example 4 | 1 | 6.93 | — | 6.93 | 99.0 | 9 |
| Example 5 | 1 | 6.95 | — | 6.95 | 99.3 | 7 |
| Example 6 | 1 | 6.94 | — | 6.94 | 99.1 | 6 |
| Example 7 | 1 | 6.96 | — | 6.96 | 99.4 | 5 |
| Example 8 | 1 | 6.97 | — | 6.97 | 99.6 | 5 |
| Example 9 | 1 | 6.96 | — | 6.96 | 99.4 | 5 |
| Example 10 | 1 | 6.98 | — | 6.98 | 99.7 | 5 |
| Example 11 | 1 | 6.76 | — | 6.76 | 96.6 | 16 |
| Example 12 | 1 | 6.97 | — | 6.97 | 99.6 | 5 |
| Example 13 | 13 | 15.82 | — | 15.82 | 98.9 | 7 |
| Example 14 | 15 | 23.78 | — | 23.78 | 99.1 | 7 |
| Example 15 | 2 | 6.92 | — | 6.92 | 98.9 | 6 |
| Example 16 | 3 | 6.95 | — | 6.95 | 99.3 | 6 |
| Example 17 | 4 | 6.18 | 0.75 | 6.93 | 99.0 | 8 |
| Example 18 | 5 | 6.22 | 0.72 | 6.94 | 99.1 | 8 |
| Example 19 | 6 | 6.23 | 0.70 | 6.93 | 99.0 | 8 |
| Example 20 | 7 | 6.21 | 0.71 | 6.92 | 98.9 | 8 |
| Example 21 | 8 | 3.46 | 3.49 | 6.95 | 99.3 | 8 |
| Example 22 | 9 | 1.39 | 5.54 | 6.93 | 99.0 | 9 |
| Example 23 | 10 | 1.03 | 5.77 | 6.80 | 97.1 | 9 |
| Example 24 | 11 | 5.52 | 1.36 | 6.88 | 98.3 | 8 |
| Example 25 | 12 | 5.55 | 1.37 | 6.92 | 98.9 | 8 |
| Example 26 | 14 | 14.24 | 1.50 | 15.74 | 98.4 | 8 |
| Example 27 | 16 | 11.85 | 11.75 | 23.60 | 98.3 | 8 |
| Example 28 | 4 | 6.19 | 0.73 | 6.92 | 98.9 | 7 |
| Example 29 | 4 | 6.28 | 0.70 | 6.98 | 99.7 | 8 |
| Example 30 | 4 | 6.27 | 0.69 | 6.96 | 99.4 | 7 |
| Comparative | 1 | 0.27 | — | 0.27 | 3.9 | 20 |
| Example 1 | | | | | | |
| Comparative | 1 | 1.10 | — | 1.10 | 15.7 | 80 |
| Example 2 | | | | | | |
| Comparative | 1 | 0.27 | — | 0.27 | 3.9 | 21 |
| Example 3 | | | | | | |
| Comparative | 1 | 1.10 | — | 1.10 | 15.7 | 81 |
| Example 4 | | | | | | |
| Comparative | 1 | 6.63 | — | 6.63 | 94.7 | 6 |
| Example 5 | | | | | | |
| Comparative | 17 | 0.32 | 5.80 | 6.12 | 87.4 | 12 |
| Example 6 | | | | | | |
| Comparative | 18 | 0.55 | 5.90 | 6.45 | 92.1 | 12 |
| Example 7 | | | | | | |

*1 denotes an ozone concentration (unit: ppm).

As is apparent from Table 2, 95% or more of the binder and the additive was removed in the degreasing step (the first degreasing step and the second degreasing step) of each of the examples. It shows that the degreasing was surely conducted.

In the degreasing step of each of the examples, the degreasing was conducted sufficiently even in a short time, though it slightly varied depending on the concentration of the ammonia gas in the atmosphere, the temperature of the atmosphere, and the like in the first degreasing step. Thus the time required for the whole of the degreasing steps was successfully reduced. This is because the first resin was rapidly decomposed and removed, and accordingly the second resin was decomposed and removed rapidly.

Further, in the compact containing the binder including a high content ratio of the first resin, the treatment time was largely reduced because of a high decomposition efficiency of the binder.

On the other hand, in Comparative Examples 1 to 4 among the comparative examples, a half or more amount of the binder remained even though the degreasing was conducted for prolonged periods of time, resulting in insufficient degreasing. This is because since the atmosphere in the first degreasing step did not contain an ammonia gas, decomposition and removal of the first resin did not proceed. As a result, the first resin remained in large amounts.

Further, in Comparative Example 5, even though the decomposition of the first resin proceeded due to an action of ozone, it was not enough as an advantageous effect.

Further, the compact used in Comparative Examples 6 and 7 did not contain the first resin, so that the binder was not sufficiently decomposed under the low temperature of 150 degrees Celsius. Accordingly, even though the second degreasing step was conducted for prolonged periods of time, the degreasing was insufficient.

3-2. Evaluation in Density of Sintered Body

A density of the sintered body obtained was measured on each of the examples and the comparative examples. The density was measured on 100 of the samples by Archimedes method (defined in JIS Z 2505) and an average value was derived as a measured value.

Next, a relative density of the sintered body was calculated from each measured value. The relative density was calculated based on conditions where a relative reference of the density of SUS316L was set to be 7.98 g/cm³ (theoretical density), the same of zirconia was set to be 6.07 g/cm³ (theoretical density), and the same of nitride silicon was set to be 3.30 g/cm³ (theoretical density).

3-3. Evaluation in Dimension of Sintered Body

A dimension in the width direction of the sintered body obtained in each of the examples and the comparative examples was measured so as to evaluate variation of the dimension. The dimension was measured in such a way that dimensions of 100 samples were measured by a micrometer so as to calculate the variation.

Next, a circularity of a center hole of each sintered body was measured. The circularity was measured with a three-dimensional measuring device and an average value was calculated.

Since almost all the sintered bodies of Comparative Examples 1 and 3 had cracks, the density and the dimension were not measured.

3-4. Evaluation in Tensile Strength of Sintered Body

A sintered body to be a specimen defined in ISO 2740 was formed in the same manner as each of the examples and the comparative examples.

Then tensile strength of the specimen was measured in accordance with the testing method defined in JIS Z 2241.

The measured results obtained were relatively evaluated in accordance with the following reference.

A: Tensile strength is very large.

B: Tensile strength is large to a certain degree.

C: Tensile strength is small to a certain degree.

D: Tensile strength is very small.

3-5. Evaluation in Aesthetic Appearance of Sintered Body

An aesthetic appearance of the sintered body obtained was evaluated on each of the examples and the comparative examples. The evaluation was performed in accordance with the following reference.

A: There are no sintered bodies having damage and a crack (including a microcrack).

B: There are some sintered bodies having damage and a crack (including a microcrack).

C: There are many sintered bodies having damage and a crack (including a microcrack).

D: Almost all the sintered bodies have a crack.

Table 3 shows the evaluation results of 3-2 to 3-5.

TABLE 3

| | | Conditions of sintering step | | | |
|---|---|---|---|---|---|
| | | Temperature | Time | Atmosphere | |
| | Sample No. | [° C.] | [hour] | Type | Pressure [kPa] |
| Example 1 | 1 | 1350 | 3 | H₂ | 100 |
| Example 2 | 1 | 1350 | 3 | H₂ | 100 |
| Example 3 | 1 | 1350 | 3 | H₂ | 100 |
| Example 4 | 1 | 1350 | 3 | H₂ | 100 |
| Example 5 | 1 | 1350 | 3 | H₂ | 100 |
| Example 6 | 1 | 1350 | 3 | H₂ | 100 |
| Example 7 | 1 | 1350 | 3 | H₂ | 100 |
| Example 8 | 1 | 1350 | 3 | H₂ | 100 |
| Example 9 | 1 | 1350 | 3 | H₂ | 100 |
| Example 10 | 1 | 1350 | 3 | H₂ | 100 |
| Example 11 | 1 | 1350 | 3 | H₂ | 100 |
| Example 12 | 1 | 1350 | 3 | H₂ | 100 |
| Example 13 | 13 | 1450 | 3 | air | 100 |
| Example 14 | 15 | 1700 | 3 | Pressurized | 780 |
| | | | | nitrogen | |
| Example 15 | 2 | 1350 | 3 | H₂ | 100 |
| Example 16 | 3 | 1350 | 3 | H₂ | 100 |
| Example 17 | 4 | 1350 | 3 | H₂ | 100 |
| Example 18 | 5 | 1350 | 3 | H₂ | 100 |
| Example 19 | 6 | 1350 | 3 | H₂ | 100 |
| Example 20 | 7 | 1350 | 3 | H₂ | 100 |
| Example 21 | 8 | 1350 | 3 | H₂ | 100 |
| Example 22 | 9 | 1350 | 3 | H₂ | 100 |
| Example 23 | 10 | 1350 | 3 | H₂ | 100 |
| Example 24 | 11 | 1350 | 3 | H₂ | 100 |
| Example 25 | 12 | 1350 | 3 | H₂ | 100 |
| Example 26 | 14 | 1450 | 3 | air | 100 |
| Example 27 | 16 | 1700 | 3 | Pressurized | 780 |
| | | | | nitrogen | |
| Example 28 | 4 | 1350 | 3 | H₂ | 100 |
| Example 29 | 4 | 1350 | 3 | H₂ | 100 |
| Example 30 | 4 | 1350 | 3 | H₂ | 100 |
| Comparative | 1 | 1350 | 3 | H₂ | 100 |
| Example 1 | | | | | |
| Comparative | 1 | 1350 | 3 | H₂ | 100 |
| Example 2 | | | | | |
| Comparative | 1 | 1350 | 3 | H₂ | 100 |
| Example 3 | | | | | |
| Comparative | 1 | 1350 | 3 | H₂ | 100 |
| Example 4 | | | | | |
| Comparative | 1 | 1350 | 3 | H₂ | 100 |
| Example 5 | | | | | |
| Comparative | 17 | 1350 | 3 | H₂ | 100 |
| Example 6 | | | | | |
| Comparative | 18 | 1350 | 3 | H₂ | 100 |
| Example 7 | | | | | |

| | | Evaluation results of sintered body | | | | | |
|---|---|---|---|---|---|---|---|
| | | | | Dimensional precision | | | |
| | | Density | | Width | Through | | |
| | | Measured | Relative | dimension | hole | | |
| | Sample | value | density | (variation) | circularity | Tensile | Aesthetic |
| | No. | [g/cm³] | [%] | [mm] | [mm] | strength | appearance |
| Example 1 | 1 | 7.83 | 98 | 0.09 | 0.08 | C | B |
| Example 2 | 1 | 7.72 | 97 | 0.10 | 0.09 | A | A |
| Example 3 | 1 | 7.76 | 97 | 0.06 | 0.05 | A | A |
| Example 4 | 1 | 7.86 | 98 | 0.07 | 0.04 | A | A |
| Example 5 | 1 | 7.90 | 99 | 0.05 | 0.04 | A | A |
| Example 6 | 1 | 7.89 | 99 | 0.05 | 0.03 | A | A |
| Example 7 | 1 | 7.92 | 99 | 0.05 | 0.04 | A | A |
| Example 8 | 1 | 7.91 | 99 | 0.04 | 0.04 | A | A |
| Example 9 | 1 | 7.80 | 98 | 0.06 | 0.05 | B | A |
| Example 10 | 1 | 7.72 | 97 | 0.08 | 0.06 | C | B |
| Example 11 | 1 | 7.63 | 96 | 0.10 | 0.09 | C | A |
| Example 12 | 1 | 7.90 | 99 | 0.11 | 0.09 | A | A |
| Example 13 | 13 | 5.91 | 97 | 0.09 | 0.08 | A | A |
| Example 14 | 15 | 3.21 | 97 | 0.08 | 0.07 | A | A |
| Example 15 | 2 | 7.91 | 99 | 0.05 | 0.05 | A | A |
| Example 16 | 3 | 7.90 | 99 | 0.07 | 0.06 | A | A |
| Example 17 | 4 | 7.93 | 99 | 0.04 | 0.04 | A | A |
| Example 18 | 5 | 7.93 | 99 | 0.04 | 0.03 | A | A |
| Example 19 | 6 | 7.94 | 99 | 0.04 | 0.03 | A | A |
| Example 20 | 7 | 7.94 | 99 | 0.04 | 0.03 | A | A |
| Example 21 | 8 | 7.92 | 99 | 0.04 | 0.04 | A | A |
| Example 22 | 9 | 7.84 | 98 | 0.07 | 0.05 | A | A |
| Example 23 | 10 | 7.87 | 99 | 0.16 | 0.11 | A | A |
| Example 24 | 11 | 7.77 | 97 | 0.06 | 0.04 | A | A |
| Example 25 | 12 | 7.75 | 97 | 0.05 | 0.04 | A | A |
| Example 26 | 14 | 5.95 | 98 | 0.08 | 0.07 | A | A |
| Example 27 | 16 | 3.25 | 98 | 0.08 | 0.06 | A | A |
| Example 28 | 4 | 7.88 | 99 | 0.06 | 0.06 | A | A |
| Example 29 | 4 | 7.94 | 99 | 0.04 | 0.04 | A | A |
| Example 30 | 4 | 7.92 | 99 | 0.05 | 0.03 | B | A |
| Comparative | 1 | — | — | — | — | D | D |
| Example 1 | | | | | | | |
| Comparative | 1 | 7.20 | 90 | 0.57 | 0.50 | C | C |
| Example 2 | | | | | | | |
| Comparative | 1 | — | — | — | — | D | D |
| Example 3 | | | | | | | |
| Comparative | 1 | 7.21 | 90 | 0.61 | 0.49 | C | C |
| Example 4 | | | | | | | |
| Comparative | 1 | 7.54 | 94 | 0.10 | 0.09 | C | C |
| Example 5 | | | | | | | |
| Comparative | 17 | 7.25 | 91 | 0.32 | 0.29 | C | C |
| Example 6 | | | | | | | |
| Comparative | 18 | 7.27 | 91 | 0.33 | 0.28 | C | C |
| Example 7 | | | | | | | |

As is apparent from Table 3, each sintered body that was obtained in each of the examples had a relative density of 96% or more to be a dense body. The sintered body that was obtained in each of the examples had a relatively favorable dimensional precision.

The sintered body that was obtained in each of the examples also had an excellent mechanical property (tensile strength). Especially the sintered body formed through the intermediate step had such tendency prominently.

Further, the sintered body obtained in each of the examples had an excellent aesthetic appearance.

On the other hand, some sintered bodies obtained in the comparable examples had a low relative density such as less than 95%. It is considered because the degreasing was insufficient due to the reason described above. Further, the binder and the additive that were failed to be removed due to the insufficient degreasing rapidly decomposed in the sintering step and were exhausted from the degreasing, causing damage of the shape of the degreased body (sintered body) or cracks therein. Thus some sintered bodies obtained in each of the comparative examples had prominently low dimensional precision or had inferior mechanical property or an aesthetic appearance.

What is claimed is:

1. A composition for forming a compact, comprising:
a powder mainly composed of an inorganic material;
a first resin being decomposable by an action of an alkaline gas; and
a binder including the first resin, wherein the first resin is decomposed and removed from the compact formed by molding the composition for forming a compact by exposing the compact to a first atmosphere containing an alkaline gas so as to obtain a degreased body.

2. The composition for forming a compact according to claim 1, wherein the first resin is decomposed at a temperature of from 20 to 190 degrees Celsius in the first atmosphere.

3. The composition for forming a compact according to claim 1, wherein the first resin includes an aliphatic polyester based resin as a main constituent.

4. The composition for forming a compact according to claim 3, wherein the aliphatic polyester based resin includes at least one of an aliphatic carbonic acid ester based resin and a polyhydroxycarboxylic acid based resin.

5. The composition for forming a compact according to claim 4, wherein the aliphatic carbonic acid ester based resin includes a carbon number of from 2 to 11 in a part except a carbonate ester group in a repeating unit.

6. The composition for forming a compact according to claim 4, wherein the aliphatic carbonic acid ester based resin has no unsaturated bonds in a part except a carbonate ester group.

7. The composition for forming a compact according to claim 4, wherein the polyhydroxycarboxylic acid based resin includes at least one of a poly lactic acid based resin and a polyglycolic acid based resin.

8. The composition for forming a compact according to claim 3, wherein the aliphatic polyester based resin has a weight average molecular weight of 10,000 to 300,000.

9. The composition for forming a compact according to claim 1, wherein a content ratio of the first resin in the binder is 20 wt % or more.

10. The composition for forming a compact according to claim 1, wherein a content ratio of the binder in the composition for forming a compact is from 2 to 40 wt %.

11. The composition for forming a compact according to claim 1, wherein the binder further includes a second resin decomposing later than the first resin.

12. The composition for forming a compact according to claim 11, wherein the second resin is decomposed at a temperature of from 180 to 600 degrees Celsius.

13. The composition for forming a compact according to claim 11, wherein the second resin includes at least one of polystyrene and polyolefin as a main constituent.

14. The composition for forming a compact according to claim 1, wherein an alkaline gas concentration of the first atmosphere is from 20 vol % to 100 vol %.

15. The composition for forming a compact according to claim 1, wherein the compact is exposed at least once to a second atmosphere containing a low concentrated alkaline gas whose alkaline gas concentration is lower than the alkaline gas concentration of the first atmosphere after being exposed to the first atmosphere so as to obtain the degreased body.

16. The composition for forming a compact according to claim 15, wherein the second atmosphere used in a final stage of exposing the compact to the second atmosphere does not substantially include an alkaline gas.

17. The composition for forming a compact according to claim 15, wherein a temperature of the second atmosphere is lower than a temperature of the first atmosphere.

18. The composition for forming a compact according to claim 15, wherein the second atmosphere includes a non-oxygenated gas as a main constituent other than the alkaline gas.

19. The composition for forming a compact according to claim 15, wherein the compact is exposed to the first atmosphere and the second atmosphere in a continuous furnace.

20. The composition for forming a compact according to claim 19, wherein the continuous furnace has a zone arranged to have an alkaline gas concentration inside the continuous furnace decreased in a middle of a traveling direction of the compact so that the compact is sequentially exposed to the first atmosphere and the second atmosphere while the compact passes through the zone.

21. A degreased body obtained by degreasing the compact that is obtained by molding the composition for forming a compact according to claim 1 through exposure to the second atmosphere.

22. The degreased body according to claim 21, the degreased body being formed from the compact molded by one of injection molding and extrusion molding.

23. A sintered body formed by sintering the degreased body according to claim 21.
